(19) United States
(12) Patent Application Publication
(10) Pub. No.: US 2019/0236675 A1
(43) Pub. Date: Aug. 1, 2019

(54) MEDIATION APPARATUS, MEDIATION METHOD, AND COMPUTER READABLE MEDIUM

(71) Applicant: Mitsubishi Electric Corporation, Tokyo (JP)

(72) Inventor: Takehiro ISHIGURO, Tokyo (JP)

(73) Assignee: Mitsubishi Electric Corporation, Tokyo (JP)

(21) Appl. No.: 16/096,234

(22) PCT Filed: Nov. 29, 2016
(86) PCT No.: PCT/JP2016/085273

§ 371 Date: Oct. 24, 2018

(30) Foreign Application Priority Data
Jun. 7, 2016 (JP) PCT/JP2016/066942

(51) Int. Cl. G06Q 30/06; G06Q 10/08

(52) U.S. Cl. CPC G06Q 30/0625; G06Q 10/0833

(57) ABSTRACT

A storage unit (120) stores desired purchase information (14), supplier company information (17), and supplier product information (18). A matching unit (130) selects a supplier (30) as a selected supplier from the supplier company information (17) based on the desired purchase information (14). Moreover, the matching unit (130) determines a degree to which specifications of a supply product which the selected supplier supplies match specifications of a desired purchase product. In a case where the degree is smaller than a threshold value, the matching unit (130) analyzes a difference between the specifications of the supply product which the selected supplier supplies and the specifications of the desired purchase product. Then, the matching unit (130) determines whether to extract information about the supply product of the selected supplier from the supplier product information (18), based on a result of analysis.

### TECHNICAL FIELD

The present invention relates to a mediation apparatus, a mediation method, and a mediation program.

### BACKGROUND ART

Patent Literatures 1 and 2 disclose a method of allowing a buyer to refer to product specifications and evaluation information about suppliers on the Web and select an optimum supplier. Moreover, Patent Literature 3 discloses a method of posting desired purchase information about a buyer on the Web and implementing a transaction from the side of a supplier. Then, Patent Literature 4 discloses a method of matching pieces of information about supply and demand of a buyer and a supplier and then communicating the matched pieces of information to both the buyer and the supplier.

Moreover, Patent Literature 5 discloses a method of selecting, from a plurality of component procurement destinations, a destination that is optimal in cost with use of production planning information about a production base, thus reducing the costs required for products. Moreover, Patent Literature 6 discloses a commercial transaction method of, at the time of ordering of components, searching for warehouses in which the components are in stock and shipping, by proxy, the components from a warehouse that is optimal in terms of transportation time and cost.

### CITATION LIST

### Patent Literature

Patent Literature 1: JP-A-2002-007647

Patent Literature 2: JP-A-2015-219555

Patent Literature 3: JP-A-2003-044707

Patent Literature 4: JP-A-2015-099618

Patent Literature 5: JP-A-2000-113051

Patent Literature 6: JP-A-2006-176231

### SUMMARY OF INVENTION

### Technical Problem

In order for a buyer and a supplier in a supply chain to exchange information using the Internet to attain a desired procurement, the above-mentioned methods discussed in Patent Literatures 1 to 4 have the following two issues.

(1) In Patent Literatures 1 to 3, sharing of product information and evaluation information of a supplier is focused on, and information other than desired product information about the buyer side, for example, evaluation information about the buyer, is unlikely to be shared. Therefore, a transaction is apt to progress in favor of the buyer, and a vicious buyer who performs, for example, unfair haggling cannot be detected.
(2) In the case of associating desired product information about a buyer and product information about a supplier with each other with the use of a matching technique such as that disclosed in Patent Literature 4, only products which are absolutely consistent in specifications can be detected. Therefore, it is impossible to create sales opportunities of a supplier who is able to satisfy the specifications only by slightly modifying the specifications.

Moreover, in order for a buyer in a supply chain to perform component procurement from an optimum supplier using the internet, the above-mentioned methods discussed in Patent Literatures 5 and 6 have the following two issues.

(3) In Patent Literatures 5 and 6, a buyer has to previously understand from which supplier or warehouse the components intended to be procured can be procured and has to previously determine a candidate for transportation means of the components. Thus, in situations in which commercial products or transportation means are constantly changed, such as in an open market, the required time and effort would increase.
(4) In Patent Literatures 5 and 6, transportations in individual transactions are independently handled. Therefore, even in a situation in which, if a plurality of transactions is collectively handled, the efficiency of transportation can be improved, cost may be increased due to individual shipment.

The present invention is directed to attaining a fairer transaction with use of evaluation information about a supplier and evaluation information about a buyer. Moreover, the present invention is directed to automatically performing flexible matching with use of these pieces of evaluation information, product specifications desired by a buyer, and information about, for example, product specifications and manufacturing apparatuses of a supplier and thus creating a larger number of purchasing opportunities. Moreover, the present invention is directed to calculating a transportation time and a transportation cost in combination with product information provided by a supplier and transportation condition information provided by a logistics provider and allowing a buyer to make a comparison in overall prices and delivery times, thus attaining a more flexible transaction.

### Solution to Problem

A mediation apparatus according to the present invention includes:

a storage unit to store desired purchase information including information about a desired purchase product which a buyer desires to purchase, supplier company information indicating information about a company of a supplier, and supplier product information including information about a supply product which a supplier supplies; and

a matching unit to select a supplier as a selected supplier from the supplier company information based on the desired purchase information, to determine a degree to which specifications of a supply product which the selected supplier supplies match specifications of the desired purchase product, to analyze a difference between the specifications of the supply product which the selected supplier supplies and the specifications of the desired purchase product in a case where the degree is smaller than a threshold value, and to determine, based on a result of analysis, whether to extract information about the supply product of the selected supplier from the supplier product information.

### Advantageous Effects of Invention

In a mediation apparatus according to the present invention, a matching unit selects a supplier as a selected supplier from supplier company information based on desired purchase information and determines a degree to which specifications of a supply product which the selected supplier supplies match specification of a desired purchase product. Then, in a case where the degree is smaller than a threshold value, the matching unit analyzes a difference between the specifications of the supply product which the selected supplier supplies and the specification of the desired purchase product, and determines whether to extract information about the supply product of the selected supplier from supplier product information based on a result of analysis. Therefore, in the mediation apparatus according to the present invention, a supplier which has the capability or possibility of satisfying specifications required by the buyer can be automatically extracted from the supplier company information and the supplier product information based on the desired purchase information about the buyer.

### BRIEF DESCRIPTION OF DRAWINGS

FIG. 1 is a configuration diagram of a mediation system 500 and a mediation apparatus 10 according to an embodiment 1.

FIG. 2 is a configuration diagram of transaction information 15 in the embodiment 1.

FIG. 3 is a configuration diagram of buyer evaluation information 12 in the embodiment 1.

FIG. 4 is a configuration diagram of supplier evaluation information 16 in the embodiment 1.

FIG. 5 is a configuration diagram of buyer company information 13 in the embodiment 1.

FIG. 6 is a configuration diagram of supplier company information 17 in the embodiment 1.

FIG. 7 is a configuration diagram of desired purchase information 14 in the embodiment 1.

FIG. 8 is a configuration diagram of supplier product information 18 in the embodiment 1.

FIG. 9 is a flowchart of transaction processing S100 performed by a buyer in the embodiment 1.

FIG. 10 is a flowchart illustrating another example of transaction processing S100 performed by a buyer in the embodiment 1.

FIG. 11 is a flowchart of transaction processing S200 performed by a supplier in the embodiment 1.

FIG. 12 is a flowchart illustrating another example of transaction processing S200 performed by a supplier in the embodiment 1.

FIG. 13 is a configuration diagram of a mediation apparatus 10 according to a modification example of the embodiment 1.

FIG. 14 is a configuration diagram of a mediation apparatus 10a according to an embodiment 2.

FIG. 15 is a flowchart of matching processing S400 in the embodiment 2.

FIG. 16 is a configuration diagram of a mediation apparatus 10b according to an embodiment 3.

FIG. 17 is a flowchart of trend notification processing S500 in the embodiment 3.

FIG. 18 is a configuration diagram of a mediation system 500c and a mediation apparatus 10c according to an embodiment 4.

FIG. 19 is a configuration diagram of supplier product information 18c in the embodiment 4.

FIG. 20 is a configuration diagram of first logistics information 191 of logistics information 19 in the embodiment 4.

FIG. 21 is a configuration diagram of second logistics information 192 of logistics information 19 in the embodiment 4.

FIG. 22 is a flowchart of supplier product presentation processing performed by the mediation apparatus 10c in the embodiment 4.

FIG. 23 is a flowchart of transportation calculation processing performed by a mediation apparatus 10c according to an embodiment 5.

### DESCRIPTION OF EMBODIMENTS

Hereinafter, embodiments of the present invention will be described with reference to the drawings. Furthermore, in the drawings, the same or equivalent portions are assigned the respective same reference characters. In describing the embodiments, with regard to the same or equivalent portions, the description thereof is omitted or simplified as appropriate.

### Embodiment 1

### Description of Configuration

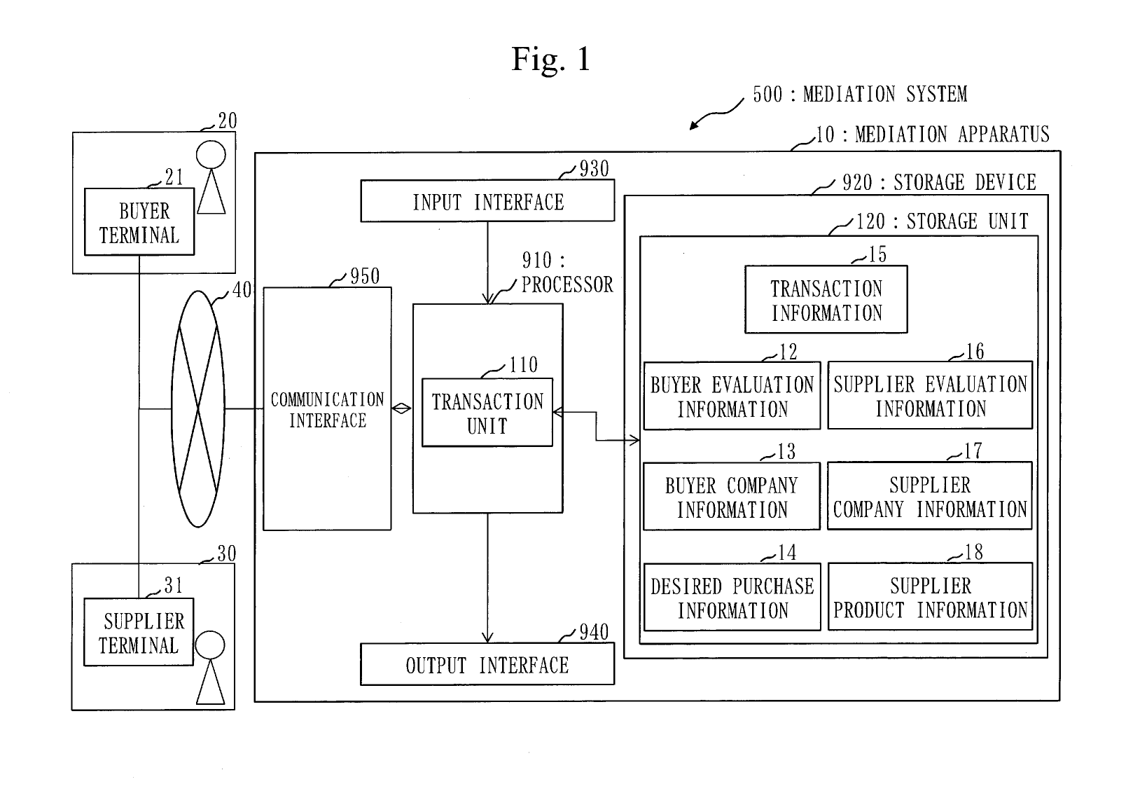

Configurations of a mediation system 500 and a mediation apparatus 10 according to the present embodiment are described with reference to FIG. 1.

The mediation system 500 is a system in which a buyer 20 and a supplier 30 evaluate each other and, by reference to a result of evaluation thereof, the buyer 20 looks for products which the supplier 30 supplies and the supplier 30 looks for products which the buyer 20 desires. Each of the buyer 20 and the supplier 30 includes a single one or a plurality of ones. The mediation system 500 has a configuration in which a buyer terminal 21, which is installed to be used by the buyer 20, a supplier terminal 31, which is installed to be used by the supplier 30, and a mediation apparatus 10, which mediates a procurement, are interconnected via the Internet 40. The mediation apparatus 10 can include a plurality of ones, but, in a case where a plurality of apparatuses is employed, pieces of data about the buyer 20 and the supplier 30 stored in the respective apparatuses have to be stored in a shareable manner.

In FIG. 1, the mediation apparatus 10 includes a transaction unit 110 and a storage unit 120. The storage unit 120 stores buyer evaluation information 12, buyer company information 13, desired purchase information 14, transaction information 15, supplier evaluation information 16, supplier company information 17, and supplier product information 18. The buyer terminal 21 of the buyer 20 connects to the transaction unit 110 of the mediation apparatus 10 via the Internet 40. The supplier terminal 31 of the supplier 30 also connects to the transaction unit 110 of the mediation apparatus 10 via the Internet 40. The transaction unit 110 responds to requests from the buyer terminal 21 and the supplier terminal 31 using the buyer evaluation information 12, the buyer company information 13, the desired purchase information 14, the transaction information 15, the supplier evaluation information 16, the supplier company information 17, and the supplier product information 18.

Next, a configuration of the mediation apparatus 10 according to the present embodiment is described.

In the present embodiment, the mediation apparatus 10 is a computer. The mediation apparatus 10 includes a processor 910 as well as other hardware such as a storage device 920, an input interface 930, an output interface 940, and a communication interface 950. The storage device 920 includes a memory and an auxiliary storage device.

As illustrated in FIG. 1, the mediation apparatus 10 includes, as functional constituents, the transaction unit 110 and the storage unit 120. In the following description, the transaction unit 110 included in the mediation apparatus 10 is referred to as a function of a “unit” of the mediation apparatus 10.

The function of a “unit” of the mediation apparatus 10 is implemented by software.

Moreover, the storage unit 120 is implemented by the storage device 920.

The processor 910 is connected to other pieces of hardware via signal lines and controls these other pieces of hardware.

The processor 910 is an integrated circuit (IC) which performs processing. Specifically, the processor 910 is, for example, a central processing unit (CPU).

The input interface 930 is a port which is connected to an input device such as a mouse, a keyboard, or a touch panel. Specifically, the input interface 930 is a universal serial bus (USB) terminal. Furthermore, the input interface 930 can be a port which is connected to a local area network (LAN).

The output interface 940 is a port to which a cable of a display instrument such as a display is connected. The output interface 940 is, for example, a USB terminal or a high-definition multimedia interface (HDMI (registered trademark)) terminal. Specifically, the display is a liquid crystal display (LCD).

The communication interface 950 includes a receiver and a transmitter. Specifically, the communication interface 950 is a communication chip or a network interface card (NIC). The communication interface 950 functions as a communication unit which performs communication of data. The receiver functions as a receiving unit which receives data, and the transmitter functions as a transmitting unit which transmits data.

Specifically, the auxiliary storage device is a read only memory (ROM), a flash memory, or a hard disk drive (HDD). Specifically, the memory is a random access memory (RAM). The storage unit 120 can be implemented by the auxiliary storage device, can be implemented by the memory, or can be implemented by the memory and the auxiliary storage device. The method of implementing the storage unit 120 is optional.

The auxiliary storage device stores a program for implementing the function of a “unit”. This program is loaded on the memory, read into the processor 910, and then executed by the processor 910. The auxiliary storage device also stores an operating system (OS). At least a part of the OS is loaded on the memory, and the processor 910, while executing the OS, executes the program for implementing the function of a “unit”.

The mediation apparatus 10 can include a plurality of processors which serves as a substitute for the processor 910. The plurality of processors shares execution of the program for implementing the function of a “unit”. Each processor is an IC which performs processing in the same manner as the processor 910.

Information, data, signal values, and variable values indicating a result of processing performed by the function of a “unit” are stored in the memory, the auxiliary storage device, or a register or cache memory included in the processor 910. Furthermore, in FIG. 1, an arrow connecting each unit and a storage unit represents each unit storing a result of processing in the storage unit or each unit reading out information from the storage unit. Moreover, an arrow connecting units represents a flow of control.

The program for implementing the function of a “unit” of the mediation apparatus 10 can be stored in a portable recording medium, such as a magnetic disc, a flexible disc, an optical disc, a compact disc, a Blu-ray (registered trademark) Disc, or a digital versatile disc (DVD).

Furthermore, the program for implementing the function of a “unit” of the mediation apparatus 10 is also referred to as a “mediation program 520”. Moreover, what is referred to as a “mediation program product” is a storage medium or storage device on which the mediation program 520 is recorded, and is a product on which a computer-readable program is loaded, irrespective of its apparent form.

Next, each piece of information stored in the storage unit 120 of the mediation apparatus 10 is described.

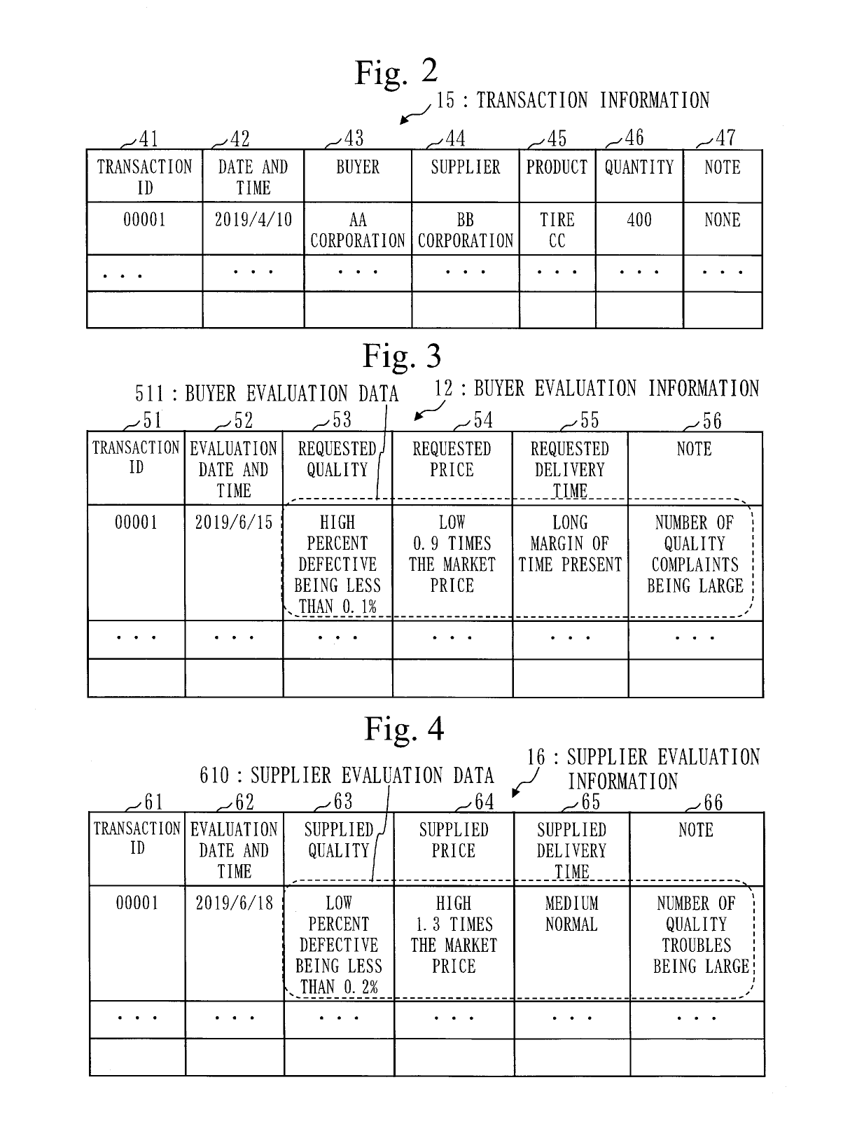

FIG. 2 is a diagram illustrating a configuration of the transaction information 15 in the present embodiment.

As illustrated in FIG. 2, the transaction information 15 is configured with pieces of information about a transaction ID 41, date and time 42, buyer 43, supplier 44, product 45, quantity 46, and note 47. The transaction ID 41 is an ID which is uniquely assigned to every transaction performed between a buyer and a supplier with use of the mediation system 500. The date and time 42 is a date and time at which the transaction was attained, and the buyer 43 and the supplier 44 are a purchaser and a seller of the transaction, respectively. The product 45 is a product name indicating on what product the transaction was performed, and can be, for example, a model name instead. The quantity 46 indicates by what quantity the product 45 was traded. The note 47 is another type of information to be written about the transaction. Specifically, information indicating that, for example, the transaction is an order with special specifications or is a quick delivery order is written in the note 47. The transaction information 15 is surely recorded when a transaction has been performed between the buyer 20 and the supplier 30 with use of the transaction unit 110, and is associated with other information via the transaction unit 110.

FIG. 3 is a diagram illustrating a configuration of the buyer evaluation information 12 in the present embodiment. The buyer evaluation information 12 includes buyer evaluation data 511 indicating a result of evaluation of a buyer. The buyer evaluation information 12 includes buyer evaluation data 511 with respect to each of a requested quality 53, requested price 54, and requested delivery time 55, which the buyer requested about a purchase product which the buyer previously purchased.

Specifically, as illustrated in FIG. 3, the buyer evaluation information 12 is configured with pieces of information about a transaction ID 51, evaluation date and time 52, requested quality 53, requested price 54, requested delivery time 55, and note 56. The transaction ID 51 is the same one as the transaction ID 41 written in the transaction information 15. The evaluation date and time 52 is a date and time at which the supplier 30 made this evaluation. The requested quality 53, requested price 54, and requested delivery time 55 are a quality, price, and delivery time, respectively, which the buyer 20 requested from the supplier 30 in the present transaction.

In the requested quality 53, requested price 54, and requested delivery time 55, pieces of information indicating “low” to “high”, pieces of information indicating “short” to “long”, pieces of information indicating “1” to “10”, and qualitative or quantitative information for describing them are set as the buyer evaluation data 511. Specifically, in the requested quality 53, “high” and “percent defective being less than 0.1%” are set as the buyer evaluation data 511.

In the note 56, qualitative or quantitative buyer evaluation data 511 which is noteworthy about the buyer 20 in aspects other than the quality, price, and delivery time are set. Specifically, in the note 56, “number of quality complaints being large” is set.

These pieces of buyer evaluation data 511 represent an evaluation which the supplier 30 made of the buyer 20 after the transaction. Moreover, with regard to the requested quality 53, requested price 54, requested delivery time 55, and note 56, it is not essential to evaluate all of the items, and the supplier 30 sets an evaluation of the buyer 20 to the extent possible.

FIG. 4 is a diagram illustrating a configuration of the supplier evaluation information 16 in the present embodiment.

The supplier evaluation information 16 includes supplier evaluation data 610 indicating a result of evaluation of a supplier. The supplier evaluation information 16 includes supplier evaluation data with respect to each of a supplied quality 63, supplied price 64, and supplied delivery time 65 of a supplied product which the supplier previously supplied.

As illustrated in FIG. 4, the supplier evaluation information 16 is also configured with pieces of information about a transaction ID 61, evaluation date and time 62, supplied quality 63, supplied price 64, supplied delivery time 65, and note 66, as with the buyer evaluation information 12. These pieces of supplier evaluation data 610 represent an evaluation which the buyer 20 makes of the supplier 30 after the transaction. Furthermore, the requested quality 53, requested price 54, and requested delivery time 55 correspond to the supplied quality 63, supplied price 64, and supplied delivery time 65.

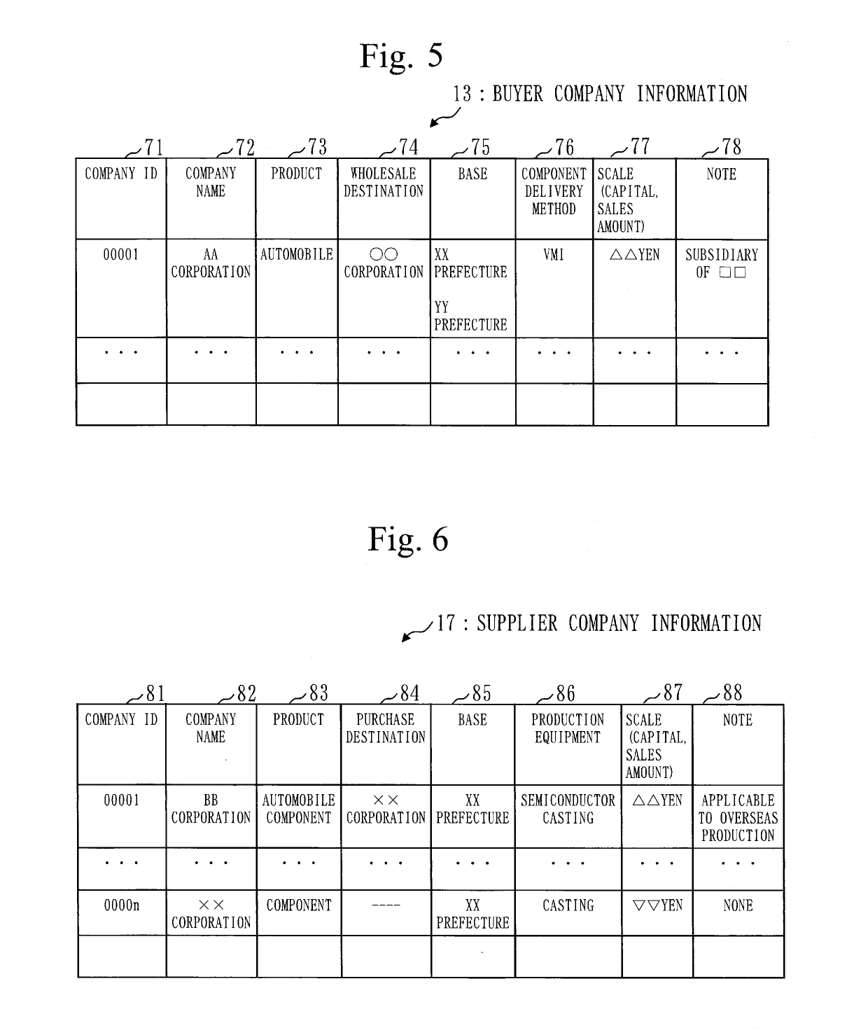

FIG. 5 is a diagram illustrating a configuration of the buyer company information 13 in the present embodiment. FIG. 6 is a diagram illustrating a configuration of the supplier company information 17 in the present embodiment.

As illustrated in FIG. 5, the buyer company information 13 is configured with pieces of information about a company ID 71, company name 72, product 73, wholesale destination 74, base 75, component delivery method 76, scale 77, and note 78. The company ID 71 is an identifier uniquely allocated to each buyer. The company name 72 is the name of the buyer. The product 73 is a product which the buyer is manufacturing. The wholesale destination 74 is the name of a wholesale destination to which the buyer is delivering the product 73. The base 75 is the location of a manufacturing base of the buyer, and the component delivery method 76 is information indicating how a supplier is delivering components at the manufacturing base. The scale 77 is the amount of money (capital or sales amount) indicating the scale of the buyer company. The note 78 is information to be written in other aspects about the buyer.

As illustrated in FIG. 6, the supplier company information 17 is also configured with pieces of information about a company ID 81, company name 82, product 83, purchase destination 84, base 85, production equipment 86, scale 87, and note 88, as with the buyer company information 13. The purchase destination 84 is a customer from which the supplier purchases components. Furthermore, a company written in the purchase destination 84 may be set as a supplier in the supplier company information 17. Moreover, the production equipment 86 is information indicating what production equipment is operating in what condition.

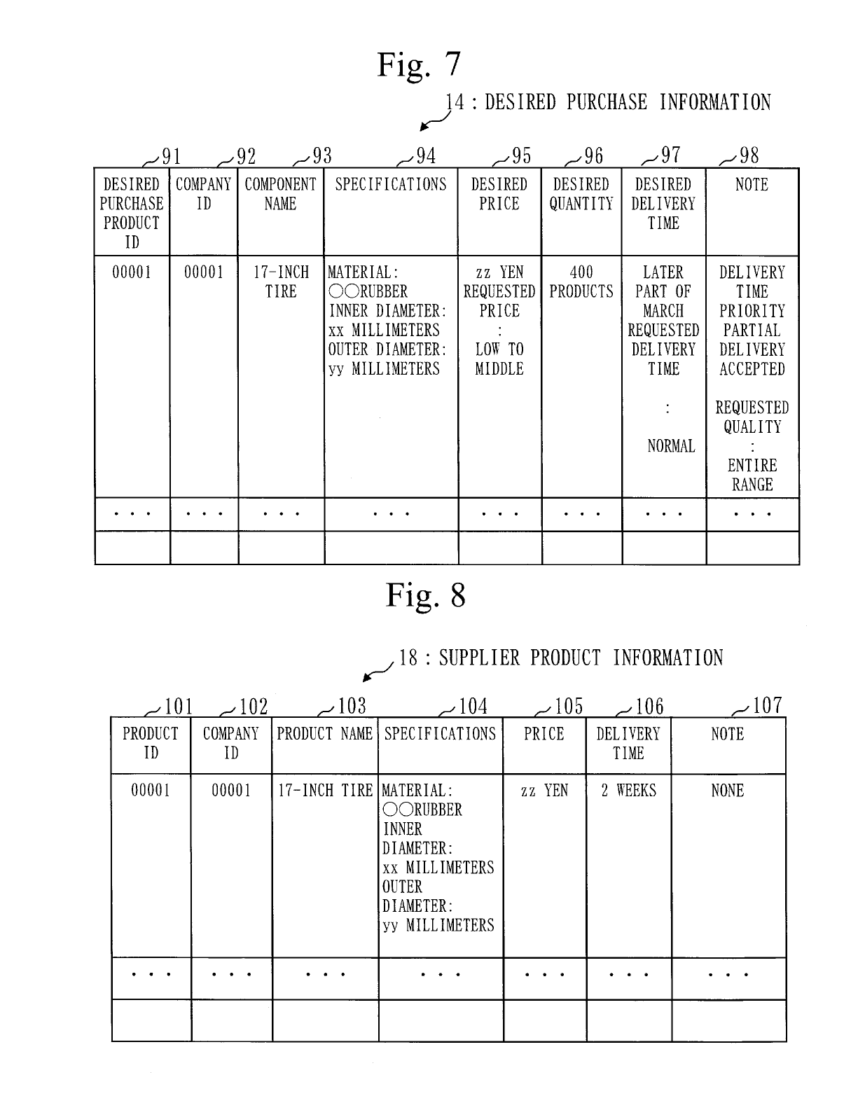

FIG. 7 is a diagram illustrating a configuration of the desired purchase information 14 in the present embodiment. The desired purchase information 14 includes information about a desired purchase product which the buyer desires to purchase. Information about a desired purchase product included in the desired purchase information 14 is also a purchase condition for the desired purchase product.

Specifically, as illustrated in FIG. 7, the desired purchase information 14 is configured with pieces of information about a desired purchase product ID 91, company ID 92, component name 93, specifications 94, desired price 95, desired quantity 96, desired delivery time 97, and note 98. The desired purchase product ID 91 is an identifier uniquely allocated to each desired purchase product for the buyer. The company ID 92 is an identifier present in the company ID 71 of the buyer company information 13. The component name 93 is the name of a desired purchase product which the buyer desires to purchase. The specifications 94 are detailed specifications explaining the desired purchase product. The desired price 95 is a desired purchase price of the desired purchase product. Furthermore, as additional information related to the desired purchase product, a supplier evaluation condition concerning an evaluation which the buyer desires to the supplier with regard to price can be set to the desired price 95. Specifically, the desired purchase price and the supplier evaluation data 610 of the supplied price of the supplier being “low” and “0.9 times or less the market price” can be set to the desired price 95. The desired quantity 96 is the number indicating how many those desired purchase products are required. The desired delivery time 97 indicates by when the buyer wants delivery of the component. A supplier evaluation condition concerning an evaluation which the buyer desires to the supplier with regard to delivery time (for example, to desire quick delivery) can also be set to the desired delivery time 97.

The note 98 is other information about the desired purchase product to be written. Specifically, the note 98 is information such as “delivery time priority”, “partial delivery accepted”, and a supplier evaluation condition concerning an evaluation which the buyer desires to the supplier with regard to quality.

FIG. 8 is a diagram illustrating a configuration of the supplier product information 18 in the present embodiment.

The supplier product information 18 includes information about a supply product which the supplier supplies.

Specifically, as illustrated in FIG. 8, the supplier product information 18 is configured with pieces of information about a product ID 101, company ID 102, component name 103, specifications 104, price 105, delivery time 106, and note 107. The product ID 101 is an identifier uniquely allocated to each supply product. The company ID 102 is an identifier present in the company ID 81 of the supplier company information 17 about the supplier which sells the supply product. The component name 103 is the name of a supply product which the supplier sells. The specifications 104 are detailed specifications explaining the supply product. The price 105 is a selling price of the supply product, and the delivery time 106 is a delivery time by which the supply product is delivered after receipt of an order thereof. The note 107 is other information about the supply product to be written.

### Description of Operation

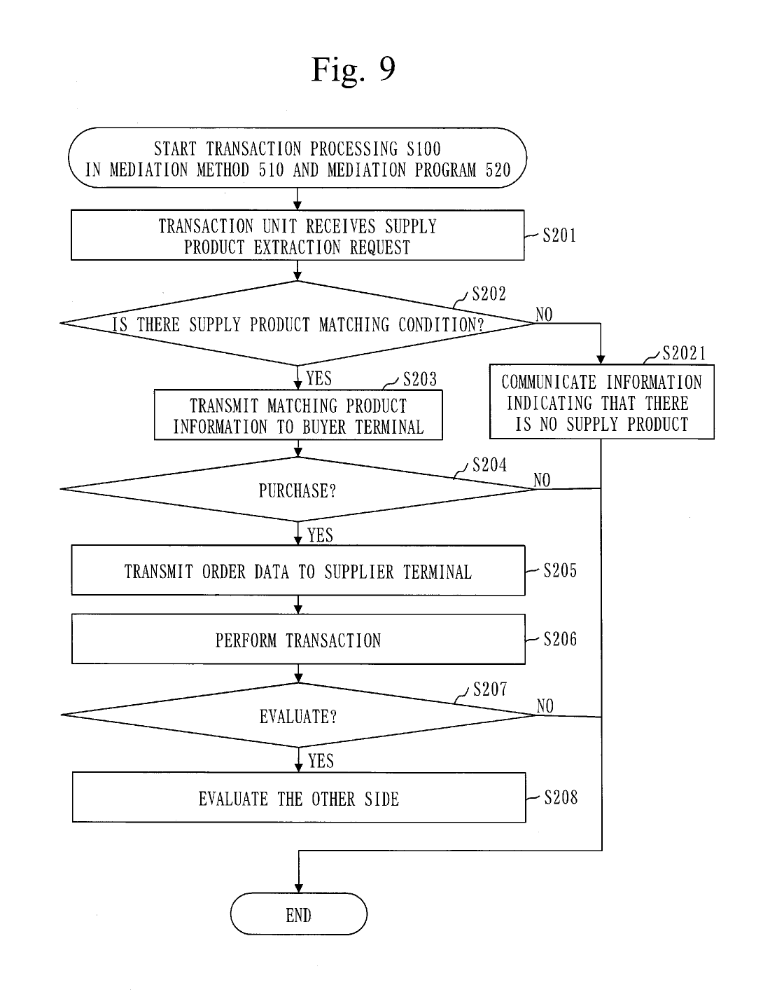

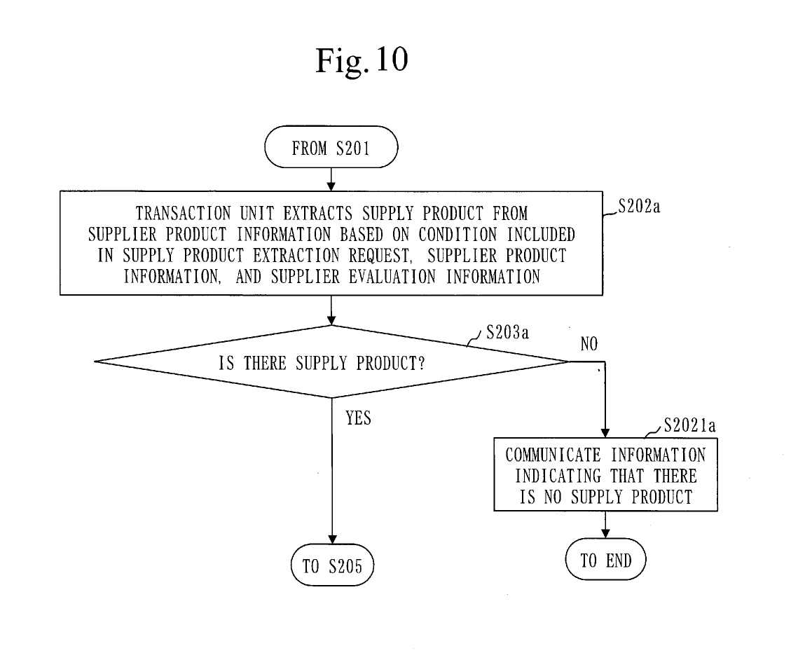

Transaction processing S100 performed by the buyer in the present embodiment is described with reference to FIG. 9. Moreover, transaction processing S100 performed by the buyer in the present embodiment is described with reference to FIG. 10.

<Advance Preparation Processing>

First, advance preparation processing, which is performed in advance, is described.

Preliminarily, the buyer 20 connects the buyer terminal 21 to the transaction unit 110 and then inputs the buyer company information 13 and the desired purchase information 14 to the extent possible. The buyer company information 13 and the desired purchase information 14 are then stored in the storage unit 120.

The supplier 30 connects the supplier terminal 31 to the transaction unit 110 and then inputs the supplier company information 17 and the supplier product information 18 to the extent possible. The supplier company information 17 and the supplier product information 18 are then stored in the storage unit 120.

Moreover, with regard to a transaction performed between the buyer 20 and the supplier 30 via the mediation apparatus 10, the transaction unit 110 records the transaction in the transaction information 15 and stores the transaction in the storage unit 120. Moreover, with regard to evaluations related to the transaction, both the buyer 20 and the supplier 30 input the respective evaluations into the supplier evaluation information 16 and the buyer evaluation information 12, respectively, via the transaction unit 110.

<Transaction Processing S100 by Buyer>

The transaction processing S100 is processing for a buyer to select a supplier, and is mainly processing for a transaction of ready-made products.

In the transaction processing S100, the transaction unit 110 acquires a supply product extraction request for extracting information about a supply product from the supplier product information 18. The supply product extraction request is a request for extracting information about a supply product from the supplier product information 18 based on a purchase condition representing a condition for a desired purchase product and a supplier evaluation condition representing a condition of the supplier evaluation data 610 which the buyer desires to a supplier who supplies the desired purchase product. Then, the transaction unit 110 extracts information about a supply product from the supplier product information 18 based on the purchase condition, the supplier evaluation condition, the supplier product information 18, and the supplier evaluation information 16. The purchase condition and the supplier evaluation condition are included in the desired purchase information 14.

The transaction processing S100 is specifically described as follows.

In step S201, the transaction unit 110 receives, from the buyer terminal 21 via the Internet 40, a supply product extraction request for searching the supplier product information 18 for a supply product satisfying a condition written in the desired purchase information 14. Specifically, the buyer 20 connects the buyer terminal 21 to the transaction unit 110 and then transmits, to the transaction unit 110, a supply product extraction request for searching the supplier product information 18 for a supply product satisfying a condition written in information for the desired purchase information 14 input by the buyer 20.

In step S202, upon receiving the supply product extraction request, the transaction unit 110 refers to the desired purchase information 14 and the supplier product information 18 and searches the supplier product information 18 for a supply product which matches the purchase condition written in the desired purchase information 14. If there is a product matching the purchase condition (YES in step S202), the transaction unit 110 advances to step S203. If there is no product matching the purchase condition (NO in step S202), then, the transaction unit 110 notifies the buyer terminal 21 that there is no supply product matching the condition (step S2021), and ends the processing.

In step S203, the transaction unit 110 transmits, to the buyer terminal 21 in reply, information about the supply product matching the condition as matching product information. The matching product information includes information required for the buyer 20 to consider purchase of the supply product, such as the company name 82 of a supplier who supplies the supply product and the component name 103, specifications 104, and price 105. Moreover, the matching product information is assumed to also include the supplier evaluation condition included in the supply product extraction request. At this time, the transaction unit 110 can cause the supplier evaluation information 16 and the supplier company information 17 about a supplier who supplies the product to be included in the matching product information.

In step S204, the buyer terminal 21 receives the matching product information. The matching product information is scrutinized by the buyer 20, and it is determined whether to purchase the supply product from the supplier. At that time, the buyer requests reference of the supplier evaluation information 16 and the supplier company information 17 about a supplier who sells a product which the buyer intends to purchase, from the transaction unit 110, and determines whether to purchase the supply product from the supplier, with use of, for example, the supplier evaluation condition. Alternatively, in a case where the supplier evaluation information 16 and the supplier company information 17 are included in the matching product information, the buyer can refer to the supplier evaluation information 16 and the supplier company information 17 included in the matching product information and determine whether to purchase the supply product.

If it is determined not to purchase the supply product (NO in step S204), the transaction unit 110 ends the processing. If it is determined to purchase the supply product (YES in step S204), the transaction unit 110 sets the supply product determined to be purchased as a supply product extracted from the supplier product information 18 and advances to step S205.

Alternatively, processing in step S202 to step S204 in FIG. 9 can be replaced by processing in step S202a to S203a in FIG. 10. In step S202a in FIG. 10, the transaction unit 110 extracts information about a supply product from the supplier product information 18 with use of the purchase condition and the supplier evaluation condition included in the supply product extraction request and the supplier product information 18 and the supplier evaluation information 16 stored in the storage unit 120. For example, when acquiring the supply product extraction request, the transaction unit 110 can extract, from the supplier product information 18, information about a supply product which satisfies the purchase condition and which a supplier whose supplier evaluation data 610 satisfies the supplier evaluation condition supplies. Moreover, a condition concerning company data about a supplier can be included in the supply product extraction request. The transaction unit 110 can refer to the supplier product information 18, the supplier evaluation information 16, and the supplier company information 17 based on the purchase condition, the supplier evaluation condition, and the condition concerning company data about a supplier and then extract information about the supply product from the supplier product information 18.

If there is an extracted supply product (YES in step S203a), the processing proceeds to step S205 in FIG. 9. If there is no extracted supply product (NO in step S203a), the transaction unit 110 notifies the buyer terminal 21 that there is no supply product matching the condition (step S2021a), and the processing proceeds to the end in FIG. 9.

Then, the transaction unit 110 transmits information about the extracted supply product to the buyer terminal 21.

In the present embodiment, pieces of information becoming useful for the buyer and the supplier to consider respective transactions are appended to the transaction information 15, the buyer company information 13, the buyer evaluation information 12, the supplier company information 17, and the supplier evaluation information 16. With this, according to processing in step S201 to step S204 in FIG. 1 9 or processing in step S201 to step S203a in FIG. 10, when the buyer selects a supply product of the supplier, the following advantageous effects can be expected.

(1) Referring to the purchase destination 84 in the supplier company information 17 enables attaining optimization in building of a supply chain, in other words, for example, a dispersion of geographical risks or a cost reduction using the same supplier.
(2) Referring to the base 85 in the supplier company information 17 enables attaining optimization of transportation, in other words, for example, a reduction in lead time or a reduction in transportation cost.
(3) Referring to the production equipment 86 in the supplier company information 17 enables measuring a reserve production capacity of the supplier based on an operational status of the equipment.
(4) Referring to the scale 87 in the supplier company information 17 enables estimating the safety of an order based on the company scale of the buyer.
(5) The note 88 in the supplier company information 17 enables utilizing advantages which are not quantitatively expressible.
(6) Evaluations concerning the supplied quality 63, the supplied price 64, and the supplied delivery time 65 of the supplier concerned from a plurality of buyers present in the supplier evaluation information 16 enable determining a transaction with the supplier concerned.
(7) The note 66 in the supplier evaluation information 16 enables knowing the goodness or badness of the supplier concerned which is not quantitatively expressible.
(8) Moreover, even the transaction information 15 subjected to statistical processing and made into a form in which individual transactions are not discriminable enables more objectively knowing the performance (for example, the number of times of transaction, the amount of transaction, or the number of transaction companies) of the supplier concerned.

In step S205, the buyer terminal 21 transmits order data to the supplier terminal 31 via the transaction unit 110. A product which the buyer orders to the supplier is a supply product determined to be purchased in step S204 or a supply product extracted by the transaction unit 110 in step S202a. The order data includes, for example, the component name and the quantity of this supply product.

In step S206, a transaction between the buyer and the supplier is started, and the transaction unit 110 stores the order data as transaction information 15 in the storage unit 120.

After completion of the transaction, in step S207, the transaction unit 110 causes each of the buyer terminal 21 and the supplier terminal 31 to determine whether to evaluate a transaction partner, and then receives a result of determination.

If an evaluation result indicating not making an evaluation is received (NO in step S207), the transaction unit 110 ends the processing. If an evaluation result indicating making an evaluation is received (YES in step S207), the transaction unit 110 advances to step S208.

In step S208, the transaction unit 110 receives a result of evaluation of the transaction partner from the buyer terminal 21 or the supplier terminal 31, and sets the result to the buyer evaluation information 12 or the supplier evaluation information 16 stored in the storage unit 120.

<Transaction Processing S200 by Supplier>

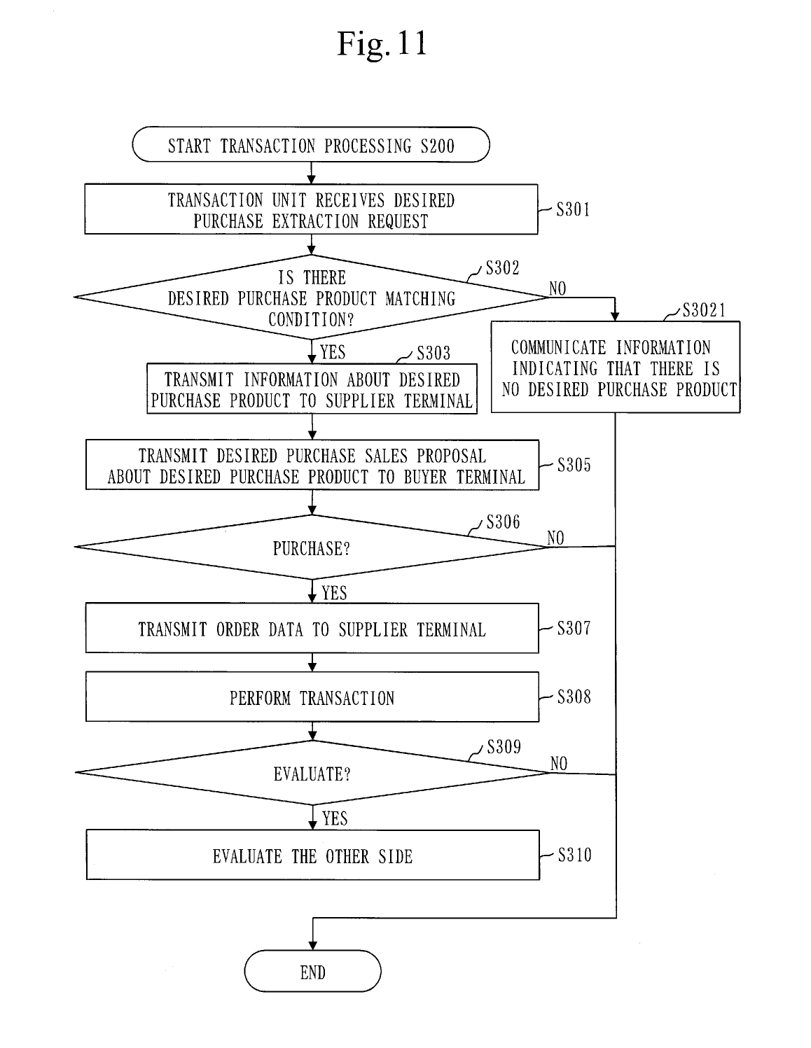

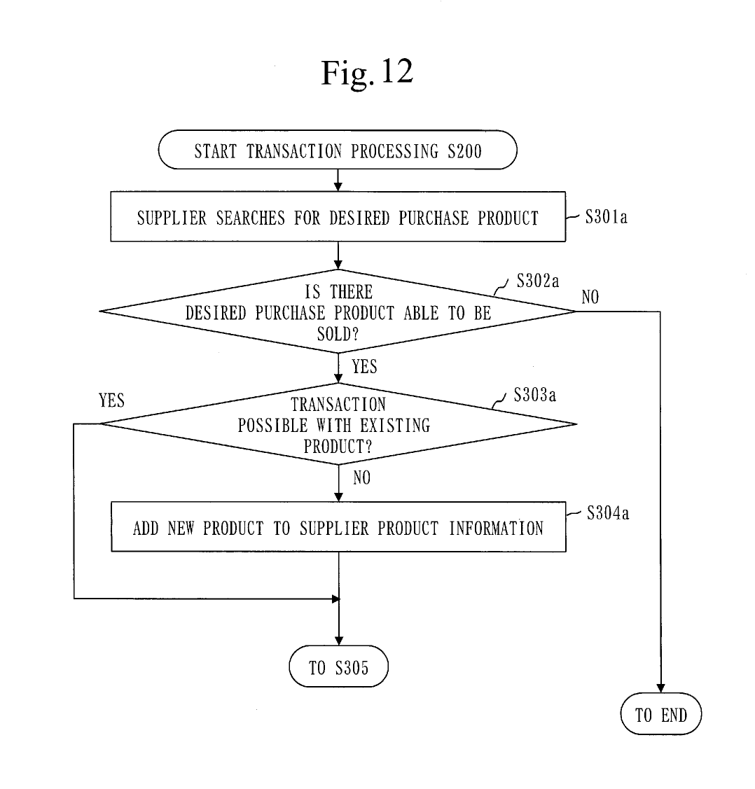

Transaction processing S200 performed by the supplier in the present embodiment is described with reference to FIG. 11. Moreover, transaction processing S200 performed by the supplier in the present embodiment is described with reference to FIG. 12.

The transaction processing S200 is processing for a supplier to select a buyer, and is mainly processing for a transaction of ordered goods.

In the transaction processing S200, the transaction unit 110 acquires a desired purchase extraction request for extracting information about a desired purchase product from the desired purchase information 14. The desired purchase extraction request is a request for extracting information about a desired purchase product from the desired purchase information 14 based on a supply condition representing a condition for a supply product which the supplier supplies and a buyer evaluation condition representing a condition of the buyer evaluation data 511 which the supplier desires to a buyer who is a supply destination to which the supplier supplies the supply product. Then, the transaction unit 110 extracts information about a desired purchase product from the desired purchase information 14 based on the supply condition, the buyer evaluation condition, the desired purchase information, and the buyer evaluation information. The supply condition is, for example, information about a supply product set in the supplier product information 18.

The transaction processing S200 is specifically described as follows.

In step S301, the transaction unit 110 receives, from the supplier terminal 31 via the Internet 40, a desired purchase extraction request for extracting the desired purchase information 14 for a desired purchase product satisfying a supply condition under which the supplier is able to supply the product. Specifically, the supplier connects the supplier terminal 31 to the transaction unit 110 and then transmits, to the transaction unit 110, a desired purchase extraction request for extracting the desired purchase information 14 for a desired purchase product.

In step S302, the transaction unit 110 extracts information about a desired purchase product from the desired purchase information 14 based on the supply condition, the buyer evaluation condition, the desired purchase information, and the buyer evaluation information. For example, when acquiring the desired purchase extraction request, the transaction unit 110 extracts, from the desired purchase information 14, information about a desired purchase product which satisfies the supply condition and which a buyer whose buyer evaluation data satisfies the buyer evaluation condition desires to purchase. If there is no desired purchase product to be extracted (NO in step S302), the transaction unit 110 notifies the supplier terminal 31 that there is no product matching the condition (step S3021), and then ends the processing. If there is a desired purchase product to be extracted (YES in step S302), the processing proceeds to step S303.

In step S303, the transaction unit 110 transmits the extracted information about a desired purchase product to the supplier terminal 31.

Furthermore, the desired purchase extraction request can include a condition concerning company data about the buyer. The transaction unit 110 refers to the desired purchase information 14, the buyer evaluation information 12, and the buyer company information 13 based on the supply condition, the buyer evaluation condition, and the condition concerning company data about the buyer, and extracts information about a desired purchase product from the desired purchase information 14.

The transaction unit 110 transmits the extracted information about a desired purchase product to the supplier terminal 31.

Alternatively, processing in step S301 to step S302 in FIG. 11 can be replaced by processing in step S301a to S304a in FIG. 12. In the case of performing processing in step S301a to S304a in FIG. 12, first, the supplier connects the supplier terminal 31 to the transaction unit 110, and looks for a product meeting a supply condition under which the supplier is able to sell the product from the desired purchase information 14 (step S301a). At this time, the supplier narrows down desired purchase products meeting a supply condition under which the supplier is able to sell the products, by reference to, for example, the product 73 of the buyer company information 13 and the specifications 94 of the desired purchase information 14 (step S302a). If, as a result of narrowing down, there is no desired purchase product (NO in step S302a), the processing ends. If, as a result of narrowing down, there is a desired purchase product (YES in step S302a), the processing proceeds to step S303a.

In step S303a, if there is an existing product which the supplier is able to sell from among the narrowed-down desired purchase products (YES in step S303a), the processing proceeds to step S305. If there is no existing product which the supplier is able to sell from among the narrowed-down desired purchase products (NO in step S303a), the processing proceeds to step S304a.

In step S304a, in a case where a new product is available for the transaction, the supplier adds the new product to the supplier product information 18, and the processing then proceeds to step S305.

As described above, according to processing in step S301 to step S303 in FIG. 11 or processing in step S301a to step S304a in FIG. 12, the supplier is able to obtain information about a desired purchase product extracted from the desired purchase information 14 based on the supply condition, the buyer evaluation data, the buyer evaluation condition, and the desired purchase information.

According to the above-described processing, when the supplier looks for a desired purchase product of the buyer, the following advantageous effects can be expected. More specifically, when searching for the desired purchase product, by referring to the buyer company information 13, the buyer evaluation information 12, and the transaction information 15, the supplier is able to estimate costs other than the price of a product and risks occurring when an order is received and to find a buyer most linked to the supplier company's profit.

(1) Specifically, referring to the wholesale destination 74 in the buyer company information 13 has the effect of preventing leakage of the supplier company's technique.
(2) Referring to the base 75 in the buyer company information 13 has the effect of, for example, a dispersion of geographical risks or a reduction in transportation cost.
(3) Referring to the component delivery method 76 in the buyer company information 13 enables confirming a compatibility with the supplier company's delivery method.
(4) Referring to the scale 77 in the buyer company information 13 enables estimating a production scale and measuring the possibility of implementation in presenting a desired purchase sales proposal to the buyer.
(5) Referring to the note 78 in the buyer company information 13 enables utilizing advantages which are not quantitatively expressible.
(6) Evaluations concerning the requested quality 53, the requested price 54, and the requested delivery time 55 of the buyer from a plurality of suppliers present in the buyer evaluation information 12 enable providing information for determining a transaction with the buyer concerned.
(7) The note 56 in the buyer evaluation information 12 enables knowing the goodness or badness of the buyer concerned which is not quantitatively expressible.
(8) Then, the transaction information 15 subjected to statistical processing and made into a form in which individual transactions are not discriminable enables more objectively knowing the performance of the buyer concerned.

In step S305, the transaction unit 110 receives, from the supplier terminal 31, a desired purchase sales proposal, which proposes that the desired purchase product is available for sale, and transmits the received desired purchase sales proposal to the buyer terminal 21. At this point of time, a transaction between the buyer, who desires to purchase the desired purchase product, and the supplier is started, and the transaction unit 110 stores the desired purchase sales proposal as transaction information 15 in the storage unit 120. The desired purchase sales proposal is also referred to as “backward order data”.

In step S306, the buyer terminal 21 receives the desired purchase sales proposal. The desired purchase sales proposal is scrutinized by the buyer, and it is determined whether to purchase the product from the supplier. At that time, the buyer requests reference of the supplier evaluation information 16 and the supplier company information 17 about a supplier who sells a product which the buyer intends to purchase, from the transaction unit 110, and determines whether to purchase the desired purchase product included in the desired purchase sales proposal by reference to the supplier evaluation information 16 and the supplier company information 17.

If it is determined not to purchase the desired purchase product (NO in step S306), the transaction unit 110 ends the processing. If it is determined to purchase the desired purchase product (YES in step S306), the transaction unit 110 advances to step S307.

In step S307, the buyer terminal 21 transmits order data, which includes, for example, the product name and the quantity, to the supplier via the transaction unit 110.

In step S308, a transaction between the buyer and the supplier is started. Furthermore, the transaction unit 110 can store the desired purchase sales proposal as transaction information 15 at the time when the desired purchase sales proposal has been transmitted to the buyer terminal 21 (step S305), or can store the order data as transaction information 15 in the storage unit 120 (step S308).

After completion of the transaction, in step S309, the transaction unit 110 causes each of the buyer terminal 21 and the supplier terminal 31 to determine whether to evaluate a transaction partner, and then receives a result of determination.

If an evaluation result indicating not making an evaluation is received (NO in step S309), the transaction unit 110 ends the processing. If an evaluation result indicating making an evaluation is received (YES in step S309), the transaction unit 110 advances to step S310.

In step S310, the transaction unit 110 receives a result of evaluation of the transaction partner from the buyer terminal 21 or the supplier terminal 31, and stores the result of evaluation as the buyer evaluation information 12 or the supplier evaluation information 16 in the storage unit 120.

### Description of Advantageous Effects of Present Embodiment

As described above, in the mediation system 500 and the mediation apparatus 10 according to the present embodiment, the buyer and the supplier are able to post company information, desired purchase information, and product information on the Web to find their transaction partners. Moreover, information about transactions which were previously performed and evaluations of transaction partners are retained together, and, by reference to all of these pieces of information, the buyer is able to select a supplier and the supplier is able to select a buyer.

In the mediation system 500 and the mediation apparatus 10 according to the present embodiment, when extracting a desired purchase product of the buyer, the supplier is able to take into consideration the buyer evaluation information about a buyer who desires to purchase the desired purchase product to be extracted, so that a fairer transaction can be attained.

Moreover, in the mediation apparatus 10 according to the present embodiment, the company information includes, for example, a company name, product area, transaction partner, site location, equipment and other conditions, and scale, which are required to consider a transaction. Moreover, the desired purchase information and the product information include a product name, product specifications, price, quantity, delivery time, and other reference information, which are required to consider a transaction. Moreover, the evaluation information includes a quantitative evaluation and a qualitative evaluation about a date and time, quality, price, and delivery time, and other reference information. Moreover, the transaction information includes, for example, a buyer, supplier, product name, quantity, and other reference information.

In this way, in the mediation apparatus 10 according to the present embodiment, both the buyer and the supplier know company information and evaluation of the other side before starting of a transaction or in the process of a transaction, so that the avoidance of a trouble and the promotion of efficiency of procurement can be attained. In order for this advantageous effect to be effectively exerted, it is important that both sides utilize this method to conduct a transaction and perform an evaluation of the other side after completion of the transaction. If these conditions are not satisfied, various pieces of data required for promotion of procurement efficiency become insufficient and thus become unable to be used as a reference during a transaction.

In the mediation system 500 and the mediation apparatus 10 according to the present embodiment, for the purpose of building of a supply chain and promotion of operation efficiency, posting evaluation information about each of the buyer and the supplier on the Web and performing bidirectional matching enable efficiently mediating a large number of procurements on a more equal basis.

While, in the description of the present embodiment, the transaction unit is implemented by a program running on a processor, a transaction server having the function of the transaction unit can be employed. Then, various pieces of information stored in the storage unit can be stored in a file server, and a configuration in which the file server and the transaction server are interconnected via, for example, a network can be used to implement the function of the mediation apparatus according to the present embodiment.

### Other Configurations

While, in the present embodiment, the function of the mediation apparatus 10 is implemented by software, the function of the mediation apparatus 10 can be implemented by hardware as a modification example.

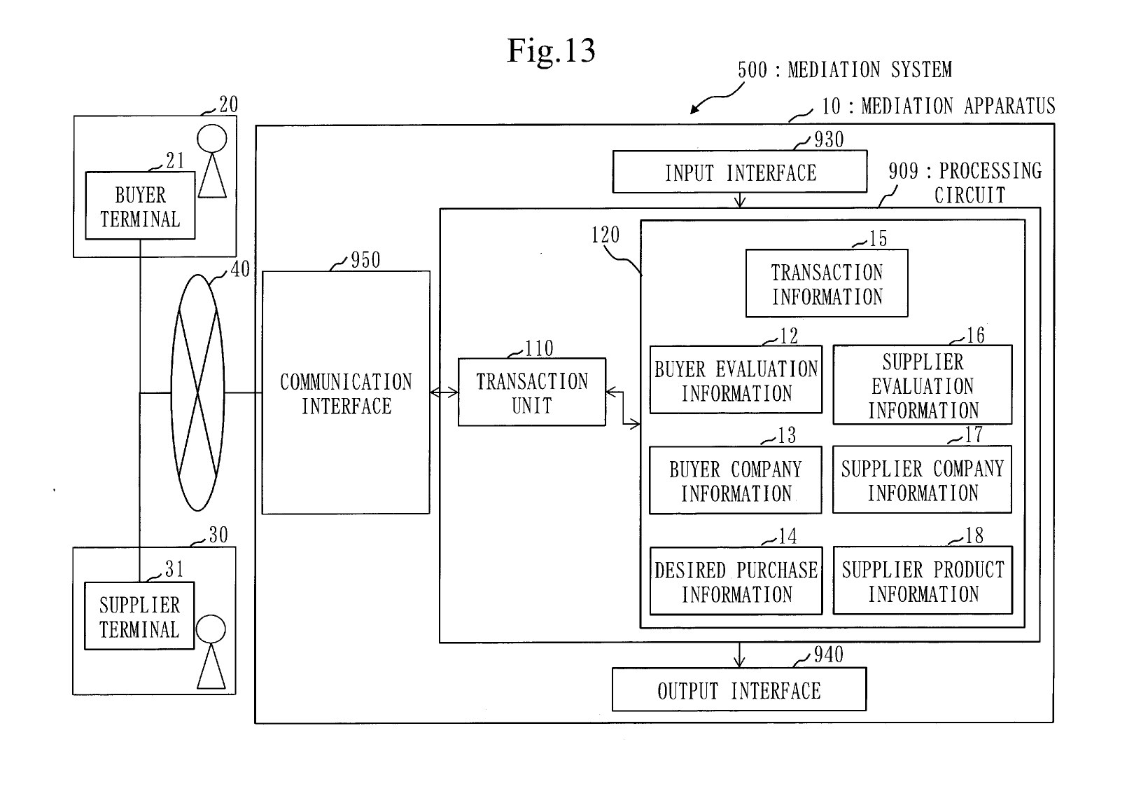

FIG. 13 is a diagram illustrating a configuration of a mediation apparatus 10 according to a modification example of the present embodiment.

As illustrated in FIG. 13, the mediation apparatus 10 includes hardware such as a processing circuit 909, an input interface 930, an output interface 940, and a communication interface 950.

The processing circuit 909 is a dedicated electronic circuit for implementing the above-mentioned function of a “unit” and a storage unit. Specifically, the processing circuit 909 is a single circuit, a composite circuit, a programmed processor, a parallel programmed processor, a logic IC, a gate array (GA), an application specific integrated circuit (ASIC), or a field-programmable gate array (FPGA).

The mediation apparatus 10 can include a plurality of processing circuits which serves as a substitute for the processing circuit 909. The function of a “unit” is implemented by the plurality of processing circuits as a whole. Each processing circuit is a dedicated electronic circuit similar to the processing circuit 909.

As another modification example, the functions of the mediation apparatus 10 can be implemented by a combination of software and hardware. In other words, a part of the functions of the mediation apparatus 10 can be implemented by dedicated hardware, and the remaining functions of the mediation apparatus 10 can be implemented by software.

The processor 910, the storage device 920, and the processing circuit 909 are collectively referred to as a “processing circuitry”. Thus, even if the configuration of the mediation apparatus 10 is a configuration illustrated in any one of FIG. 1 and FIG. 13, the function of a “unit” and the storage unit are implemented by the processing circuitry.

“Unit” can be replaced with “process”, “procedure” or “processing”. The function of a “unit” can be implemented by firmware.

### Embodiment 2

In the present embodiment, differences from the embodiment 1 are mainly described.

In the present embodiment, constituents similar to the constituents described in the embodiment 1 are assigned the respective same reference numerals, and the description thereof is omitted.

In the embodiment 1, the method in which both the buyer and the supplier look for their transaction partners by themselves has been described. However, as the numbers of buyers and suppliers increase, the numbers of desired purchase products of buyers and supply products of suppliers also become enormous.

In the present embodiment, a mediation apparatus 10a in which a matching unit 130 is added to the configuration of the embodiment 1 and which thus automatically performs matching between demand of a buyer and supply of a supplier in a method determined in advance is described.

### Description of Configuration

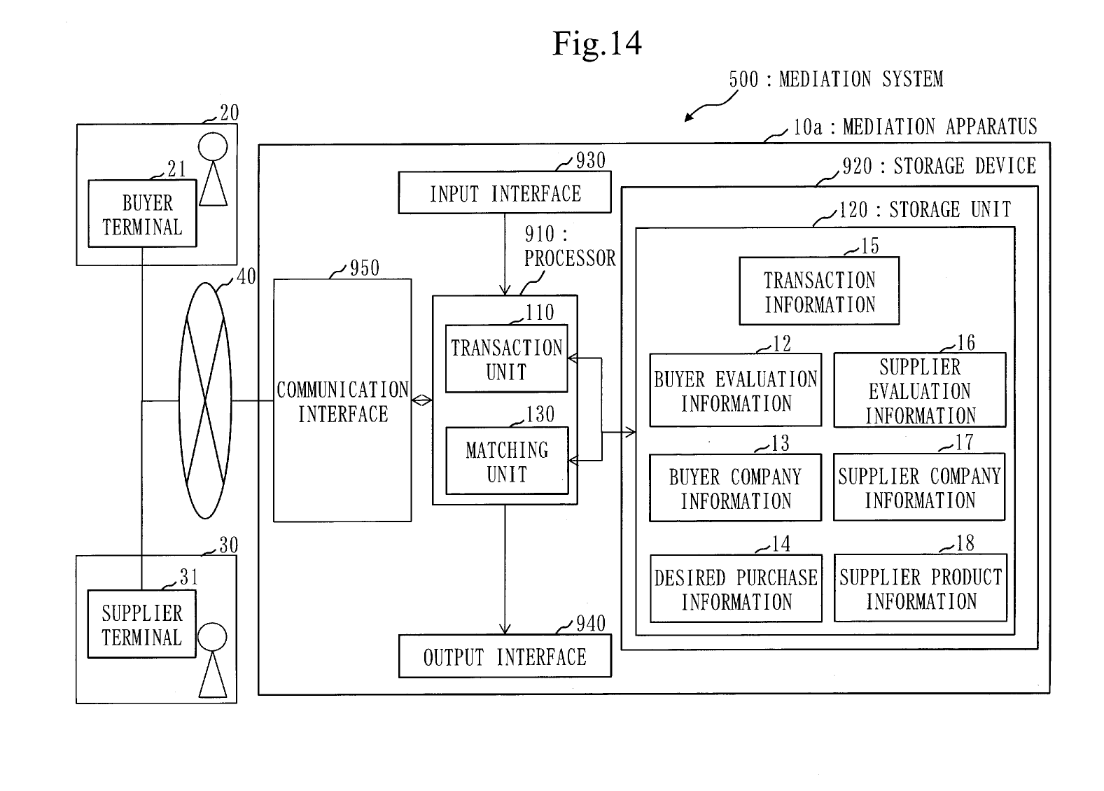

FIG. 14 is a diagram illustrating a configuration of the mediation apparatus 10a according to the present embodiment.

In the present embodiment, a matching unit 130 is included in addition to the functional configuration of the mediation apparatus 10 of the embodiment 1. The matching unit 130 is also referred to as a “matching engine”.

In the present embodiment, the matching unit 130 automatically associates the purchase desire of a buyer and the supply availability of a supplier with each other using the buyer evaluation information 12, the buyer company information 13, the desired purchase information 14, the transaction information 15, the supplier evaluation information 16, the supplier company information 17, and the supplier product information 18.

### Description of Operation

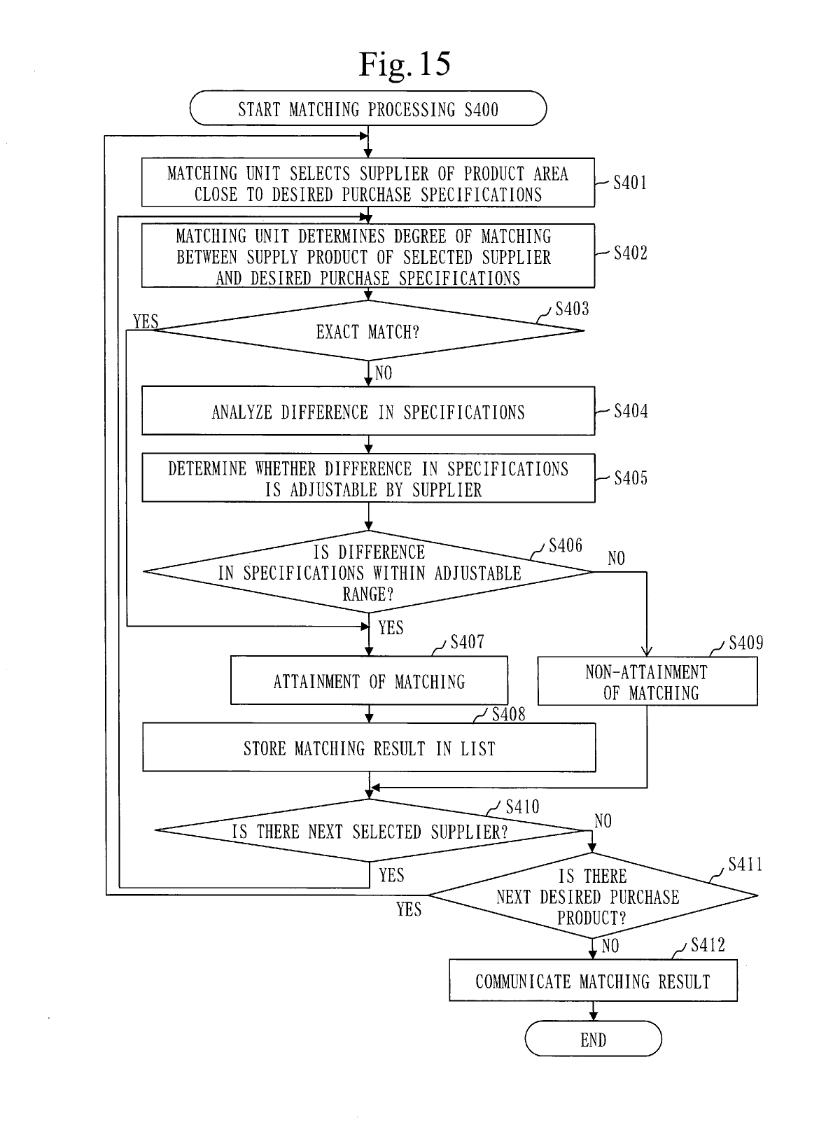

Matching processing S400 in the present embodiment is described with reference to FIG. 15.

In step S401, the matching unit 130 selects a supplier as a selected supplier from the supplier company information 17 based on the desired purchase information 14. Specifically, with regard to information about a desired purchase product which is a row in the desired purchase information 14 (hereinafter referred to as “processing target purchase desire”), the matching unit 130 selects, from the supplier company information 17, a supplier having a product area close to specifications of the processing target purchase desire (hereinafter referred to as “desired purchase specifications”). At this time, the matching unit 130 finds out a supplier having a product area close to the desired purchase specifications by reference to, for example, the following information.

(A) The matching unit 130 selects a supplier who previously conducted a transaction, by reference to the transaction information 15 about a buyer having the processing target purchase desire.
(B) The matching unit 130 selects a supplier who has a transaction result with respect to a buyer who sells a product similar to the product 73 of a buyer having the processing target purchase desire.
(C) The matching unit 130 selects a supplier who has the same product 83 as those in the above (A) and (B) in the supplier company information 17.
(D) The matching unit 130 selects a supplier who has a product similar to the component name 93 and specifications 94 of the processing target purchase desire in the supplier product information 18.

Moreover, at this stage, the matching unit 130 can store a combination of features used for extracting a supplier (for example, the component name 93 and specifications 94 in the desired purchase information 14) and a list of candidates for the selected supplier in the storage unit 120 for later selection.

In step S402, the matching unit 130 determines a degree to which specifications of a supply product which the selected supplier supplies match specifications of the desired purchase product, in other words, the desired purchase specifications. Specifically, the matching unit 130 determines a degree of matching between the specifications of a supply product which the selected supplier supplies and the desired purchase specifications with use of the supplier product information 18.

In step S403, the matching unit 130 determines whether the degree is smaller than a threshold value. For example, the threshold value is assumed to be 100%. In a case where the degree of matching in specifications is 100%, it is determined that an exact match is found, in other words, the specifications are satisfied. In a case where the degree of matching in specifications is smaller than 100%, it is determined that an exact match is not found, in other words, the specifications are not satisfied. In the case of an exact match, in other words, if, for example, the specifications 94 and desired price 95 of the component perfectly match, for example, the specifications 104 and price 105 of a product included in the supplier product information 18 about the selected supplier (YES in step S403), the matching unit 130 advances to attainment of matching in step S407.

In step S408, the matching unit 130 adds the selected supplier found by matching and the supply product thereof as a matching result to a list and stores the list.

In step S410, if there is a next selected supplier, the matching unit 130 returns to step S402 and then repeats the processing.

In step S403, if an exact match is not found, the processing proceeds to step S404.

In step S404, the matching unit 130 analyzes a difference between the specifications of the supply product of the selected supplier and the desired purchase specifications.

In step S405, the matching unit 130 determines whether to extract information about the supply product of the selected supplier from the supplier product information based on a result of analysis. Specifically, the matching unit 130 determines whether the specifications are able to be satisfied by correcting portions of the specifications where non-matching is found with respect to the selected supplier, based on information about, for example, the purchase destination 84 and the production equipment 86 of the selected supplier. For example, information indicating what material the selected supplier is purchasing is written to the purchase destination 84 (or can be disclosed to only the matching unit 130), and information indicating what equipment or process is present for material processing is written to the production equipment 86 (or can also be disclosed to only the matching unit 130). With such information written, an attempt to change the production process within a range not exceeding the specifications in material and equipment so as to bring the changed production process close to the desired purchase specifications is performed. Moreover, if a material purchase destination is also previously registered with the supplier product information 18 or the supplier company information 17, changing a material to be purchased also comes into view.

With such processing performed, if the matching unit 130 determines that a difference in specifications is adjustable (absorbable) (YES in step S406), the matching unit 130 advances to attainment of matching in step S407. In step S408, the matching unit 130 adds the supplier found by matching and the supply product thereof in the form of a proposal together with the difference in specifications to a matching result and stores the matching result in a list. Then, the matching unit 130 performs step S410.

If the matching unit 130 determines that a difference in specifications is not adjustable (absorbable) (NO in step S406), the matching unit 130 advances to non-attainment of matching in step S409. Then, the matching unit 130 advances to step S410 and repeats the processing if there is a next selected supplier.

After the processing is completed with respect to all of the selected suppliers, if there is a next row in the desired purchase information 14 (YES in step S411), the matching unit 130 returns to step S401 and then repeats the processing with the next row in the desired purchase information 14 set as the processing target purchase desire.

When the processing ends with respect to all of the rows in the desired purchase information 14 (NO in step S411), the processing proceeds to step S412. In step S412, the matching unit 130 communicates the matching result to one or both of the buyer with the processing target purchase desire registered therewith and each supplier written in the matching result. Here, since the matching result itself is highly confidential information, information about other than the supplier concerned is not communicated to the supplier side, and, moreover, non-public information about the supplier side is also not communicated to the buyer side, so that information indicating that there is a partner having the possibility of transaction is only communicated. Moreover, pieces of information to be respectively communicated to the buyer and supplier can be filtered with an evaluation made by the other side. This means that, even if the other side falling below a threshold value is found by matching, information obtained by excluding the found other side from candidates is communicated.

### Description of Advantageous Effects of Present Embodiment

As described above, in the mediation apparatus 10a according to the present embodiment, on the basis of the desired purchase information about the buyer, a supplier having the ability or possibility of satisfying requested specifications thereof, such as the size, function, and price, can be automatically extracted from supplier company information and supplier product information. Then, with regard to a degree of matching and a difference in specifications, confidential information can be formed into an abstracted state and then communicated to the buyer or the supplier or to both sides. Furthermore, the supplier company information is information including, for example, the production equipment and the purchase destination, and the supplier product information is information including, for example, a production lineup and specifications thereof.

The matching unit 130 in the present embodiment automatically associates the purchase desire of the buyer and the provision possibility of the supplier with each other based on previously registered information, and, therefore, has the following advantageous effects.

(1) The first is a reduction in troublesome operation of matching and an expansion in matching range. As the desired purchase information about buyers and the product information about suppliers increase, it becomes not easy to manually associate these pieces of information. Therefore, in a case where the buyer manually performs selection of a supplier, the buyer necessarily conducts an investigation focusing on a supplier with which a transaction was previously performed and thus performs procurements only from a limited range of suppliers. However, since matching processing in the present embodiment is automatically performed by a matching engine, for example, a transaction destination which would not be reached by manual search or a transaction destination which would not be thought of can be considered as a candidate.
(2) The second is directed to implementing efficient selection of a supplier while maintaining confidentiality. In a case where a selection operation is manually performed, a candidate is necessarily selected based on public information which is allowed to be seen by the other side and, then, it is necessary to conduct direct negotiations via, for example, telephone or e-mail. However, as in the present embodiment, if a part of information about, for example, the production equipment or transaction destination is registered in a non-public form (only a matching engine is able to be referred to), matching can be efficiently performed without the present company's confidential information being known by competitor companies. However, these pieces of confidential information enable increasing the range of matching (the number of suppliers having the possibility of meeting a request of the buyer), but, on the other hand, may have a serious influence on the present company's operation if careful handling is not performed. An advantage of the buyer side in a case where the present embodiment is used resides in the capability of extracting a larger number of supplier candidates without directly referring to confidential information about suppliers as compared with a case where the present embodiment is not used. Moreover, an advantage of the supplier side resides in the capability of easily selecting, from a large number of purchase desires of buyers, the one which the present company would be able to meet.

As with the embodiment 1, the present embodiment is also able to achieve the best matching result in a state in which a larger number of pieces of information are registered.

### Embodiment 3

In the present embodiment, differences from the embodiments 1 and 2 are mainly described.

In the present embodiment, constituents similar to the constituents described in the embodiments 1 and 2 are assigned the respective same reference numerals, and the description thereof is omitted.

In the embodiment 1, the method in which both the buyer and the supplier look for their transaction partners while referring to an evaluation of the other side has been described. Moreover, in the embodiment 2, in addition to that, the method in which the matching unit 130 automatically finds transaction partners, including potential transaction partners, based on information previously registered by both sides has been described.

In the present embodiment, a method of not creating a passive purchase opportunity which is triggered by the purchase desire of the buyer but actively creating a purchase opportunity by readjusting purchase destinations or production equipment of the present company based on information about transactions which are currently being performed with other companies is described.

### Description of Configuration

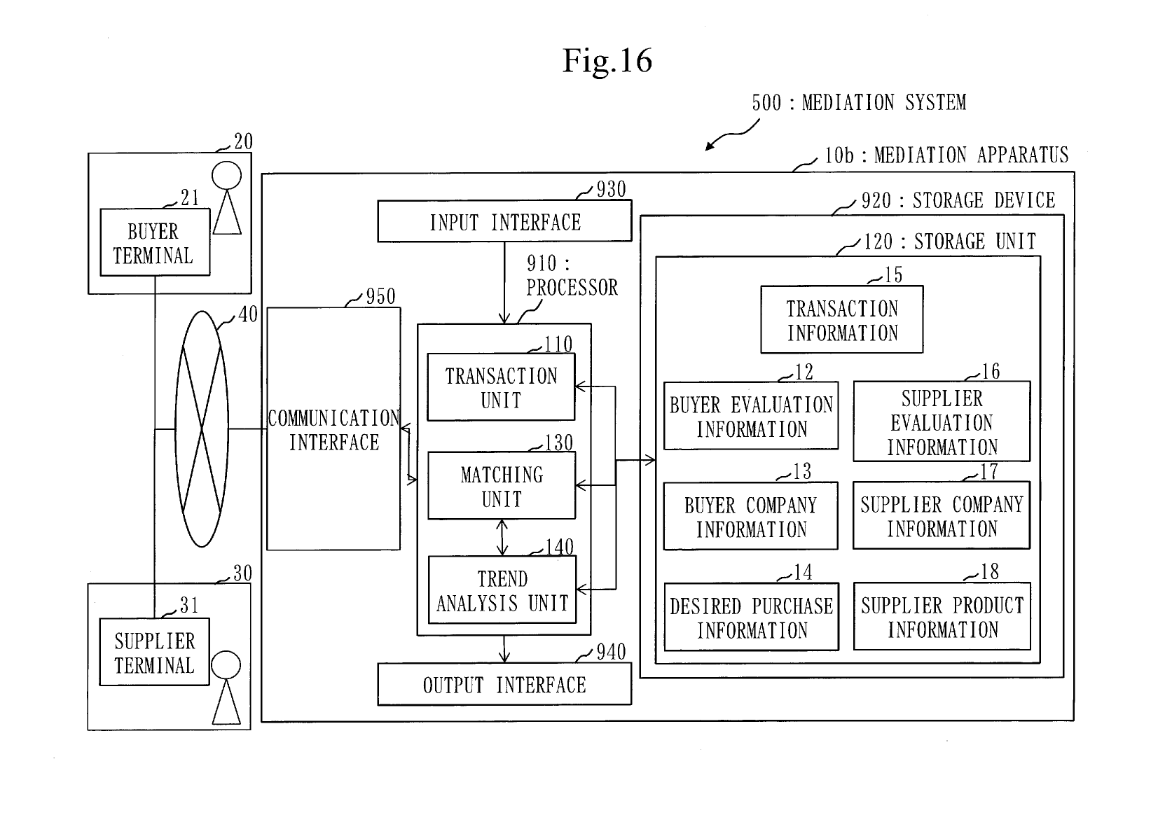

FIG. 16 is a diagram illustrating a configuration of a mediation apparatus 10b according to the present embodiment.

In the present embodiment, a trend analysis unit 140 is included in addition to the functional configuration of the mediation apparatus 10a of the embodiment 2. The trend analysis unit 140 is also referred to as a “trend analysis engine”.

The trend analysis unit 140 analyzes products of what specifications are currently needed, by reference to the transaction information 15 or the desired purchase information 14. Then, the trend analysis unit 140 communicates a trend to a supplier who is selling a product close to the needed specifications, based on a result of analysis. More specifically, the trend analysis unit 140 extracts a trend product, which tends to be traded, based on the transaction information 15 and the desired purchase information 14. In a case where there is a difference between the specifications of the trend product and the specifications of a supply product which the supplier supplies, the trend analysis unit 140 analyzes the difference. The trend analysis unit 140 communicates a trend notification about the trend product to the supplier based on a result of analysis.

### Description of Operation

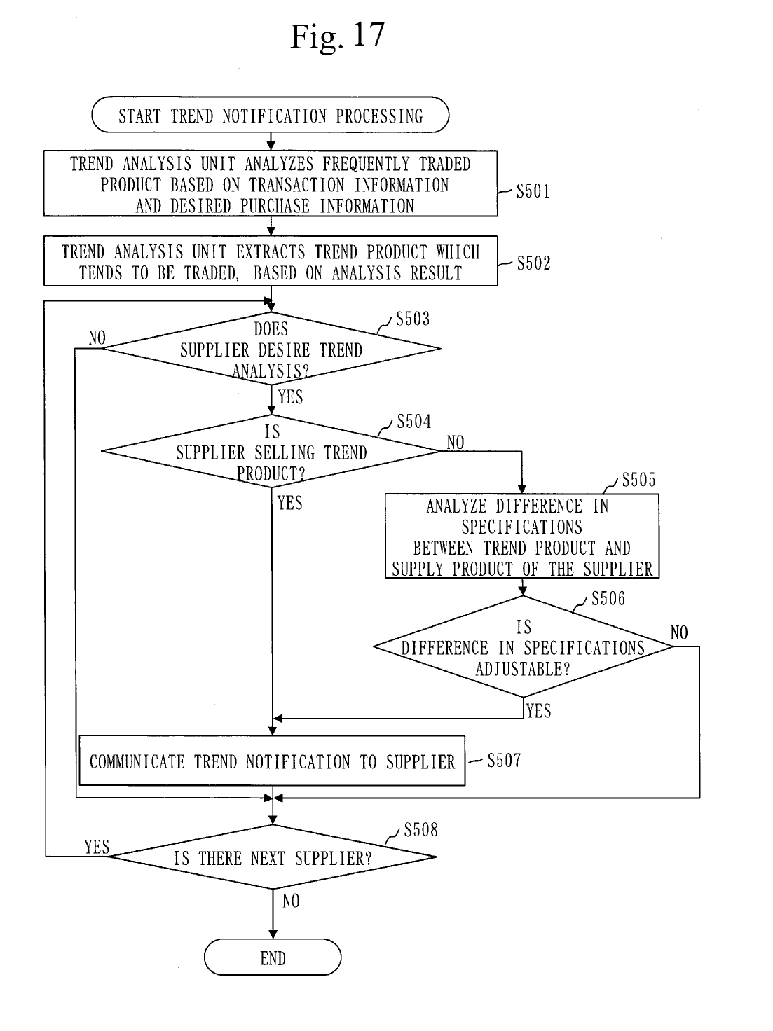

Trend notification processing S500 in the present embodiment is described with reference to FIG. 17.

In step S501, the trend analysis unit 140 analyzes what product is being frequently traded, based on the transaction information 15 and the desired purchase information 14. As a specific example, the trend analysis unit 140 analyzes a trend in which transactions are performed by, for example, dividing products registered with the transaction information 15 and the desired purchase information 14 by every product area and counting the number of transactions and the number of purchase desires for every product area.

In step S502, the trend analysis unit 140 extracts a trend product, which tends to be traded. Specifically, the trend analysis unit 140 compares a result of analysis in step S501 with the previous results of analysis, and thus performs narrowing down into two types of products, including a product the amount of transaction of which is large and a product the amount of transaction of which has an increasing tendency. Here, two types of products obtained by narrowing down are assumed to be trend products.

In step S503, the trend analysis unit 140 determines whether the supplier desires a trend analysis, based on the supplier company information 17. As a specific example, the supplier company information 17 is assumed to include a trend analysis desire item indicating whether to desire a trend analysis. The trend analysis unit 140 refers to this trend analysis desire item to determine whether the supplier desires a trend analysis.

If the supplier does not desire a trend analysis (NO in step S503), the trend analysis unit 140 determines the desire of a trend analysis with respect to a next supplier in the supplier company information 17. If the supplier desires a trend analysis (YES in step S503), the processing proceeds to step S504.

In step S504, the trend analysis unit 140 determines whether the supplier concerned is selling a product close in specifications to the above-mentioned two types of trend products. If the supplier concerned is selling a product matching the trend products (YES in step S504), the trend analysis unit 140 advances to step S507. At this time, the trend analysis unit 140 can perform processing similar to that in step S401 to step S403 illustrated in FIG. 15 to determine whether the supplier concerned is selling a product close in specifications to the trend products or to determine whether an exact match is found.

In step S507, the trend analysis unit 140 communicates, to the supplier, a trend notification indicating that a product of specifications matching the trend is in high demand or these products are increasing.

If the supplier concerned is not selling a product matching the trend products (NO in step S504), the trend analysis unit 140 advances to step S505.

In step S505, the trend analysis unit 140 analyzes a difference in specifications between the trend product and a supply product of the supplier concerned. More specifically, the trend analysis unit 140 analyzes whether the supplier concerned is selling a product of specifications not matching but close to those of the trend product or whether a difference in specifications from the trend product is adjustable by the supplier concerned.

In step S506, if the trend analysis unit 140 determines that the supplier concerned is selling a product of specifications not matching but close to those of the trend product and a difference in specifications from the trend product is adjustable (YES in step S506), the trend analysis unit 140 advances to step S507. In step S507, the trend analysis unit 140 communicates, to the supplier concerned, a trend notification indicating a prospect of an increase in orders caused by adjustment of a difference in specifications. At this time, the trend analysis unit 140 performs processing similar to that in step S404 to step S406 illustrated in FIG. 15 to perform an analysis of a difference in specifications between the trend product and the supply product of the supplier concerned and a determination as to whether the difference in specifications is adjustable by the supplier concerned.

If the trend analysis unit 140 determines that the difference in specifications is not adjustable (NO in step S506), the trend analysis unit 140 advances to step S508.

In step S508, if there is a next supplier, the trend analysis unit 140 returns to step S503, and then repeats the processing.

The trend analysis unit 140 performs the above-described procedure with respect to all of the suppliers who desire a trend analysis.

### Description of Advantageous Effects of Present Embodiment

As described, in the mediation apparatus 10b according to the present embodiment, a product which is frequently traded or which tends to increase in number can be automatically extracted based on previous transactions between the buyer and the supplier or desired purchase information which is currently posted. Then, knowing such trend information enables attaining a further increase in productivity and an expansion of the production scale.

In the trend analysis unit 140 according to the present embodiment, an analysis can be automatically performed about a trend of transaction in the world, so that the following advantageous effects can be obtained.

(1) Without having to get information about a desired product out of the buyer or to investigate what product is desired, the supplier is able to know the specifications of a product which is currently selling or is expected to be selling from now on, by obtaining a result of analysis by the trend analysis unit. That is, while, even if the buyer inquires of the respective buyer companies about desired components, definite answers cannot be obtained due to confidentiality or ambiguity, using the form of a trend extracted by the trend analysis unit from a large number of transactions or pieces of desired purchase information enables knowing the sale of what product is to be focused on with the above-mentioned problem avoided. For example, while this sort of thing has been performed by trading companies or information analysis companies with proprietary know-how, the present embodiment enables anyone involved in transactions to know a trend in an anonymous manner. Furthermore, these can be anonymized as information in such a form as not to be able to identify individual companies and thus can be sold as general trend information.
(2) Moreover, in a case where the manufacturing process of the supplier's company has an available capacity or an expansion for the scale enlargement is planned, the supplier is able to know what portion of the manufacturing process should be changed to what extent according to what method, based on the trend information. This serves as an advice to shift the production capability which the supplier has heretofore spent on a product in vanishing demand among the supplier company's products to a product (specifications) having the possibility of being in increasing demand in the future. With a product which is frequently being traded in the world and the demand of which is expanding, unless it is the one requiring a special technique or know-how, the supplier is able to newly enter into trading of the product and to acquire a sale destination thereof. At that time, the trend analysis unit is able to find a supplier from which the supplier has the possibility of acquiring an order with a minimum extent of change, based on previously registered production equipment information or purchase destination information. This enables attaining the efficient production and equipment investment which are less wasteful in terms of the whole manufacturing industry.

Furthermore, the import thing in a trend analysis is that, if a result of the trend analysis is concurrently communicated to a great number of destinations, wild ups and downs in demand may occur unnecessarily. In view of this, in the present embodiment, the range to which to communicate a trend analysis result should be restricted by parameters such as a product area and a company size. Moreover, the trend analysis result should not include information leading to identification of individual companies and is, therefore, required to be anonymized or abstracted before being communicated to the supplier.

### Embodiment 4

In the present embodiment, differences from the embodiments 1 and 2 are mainly described.

In the present embodiment, constituents similar to the constituents described in the embodiments 1 to 3 are assigned the respective same reference numerals, and the description thereof is omitted.

In the present embodiment, a mediation system 500c and a mediation apparatus 10c each of which is capable of optimizing an overall delivery time and price including a transportation time and cost of a product over a plurality of transactions so as to increase the efficiency of building and operation of a supply chain are described.

### Description of Configuration

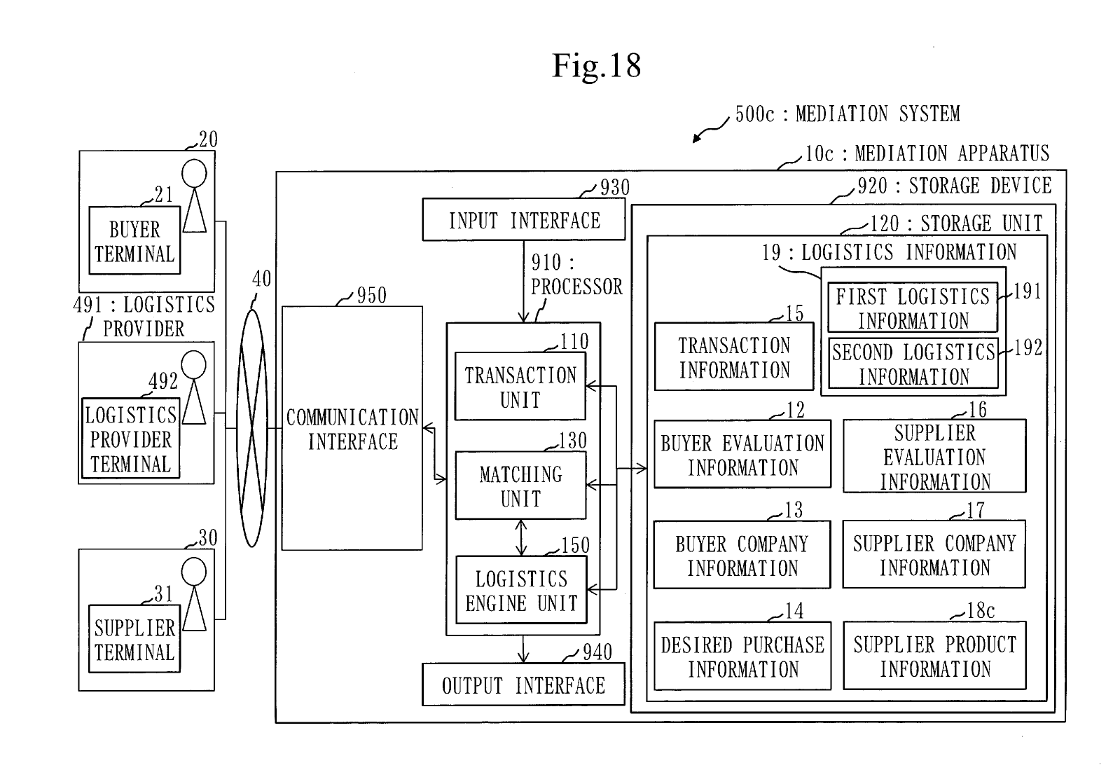

A configuration of the mediation apparatus 10c according to the present embodiment is described with reference to FIG. 18. In FIG. 18, constituents similar to those illustrated in FIG. 14 in the embodiment 2 are assigned the respective same reference characters, and the description thereof is omitted.

In FIG. 18, a difference from FIG. 14 is that the mediation apparatus 10c is connected to a logistics provider terminal 492 via the Internet 40. A logistics provider 491 is equipped with the logistics provider terminal 492. Moreover, the mediation apparatus 10c includes a logistics engine unit 150 as a functional configuration unit. Moreover, the mediation apparatus 10c includes logistics information 19 in the storage unit 120. The logistics information 19 includes first logistics information 191 and second logistics information 192. Moreover, supplier product information 18c stored in the storage unit 120 is information obtained by adding information about a production site 106c to the supplier product information 18 described in the embodiment 1.

The mediation apparatus 10c illustrated in FIG. 18 is used for the buyer 20 to look for an optimal procurement destination and a product to be procured, based on the supplier 30 and registration information about the logistics provider 491. In the mediation system 500c, one or a plurality of buyers 20, one or a plurality of suppliers 30, and one or a plurality of logistics providers 491 are connected to the mediation apparatus 10c, which mediates a procurement, via the Internet 40. The mediation apparatus 10c can include a plurality of ones, but, in a case where a plurality of apparatuses is employed, pieces of data about suppliers and logistics providers stored in the respective apparatuses have to be stored in a shareable manner.

The transaction unit 110 responds to requests from the buyer terminal 21, the supplier terminal 31, or the logistics provider terminal 492 using the buyer evaluation information 12, the buyer company information 13, the desired purchase information 14, the transaction information 15, the supplier evaluation information 16, the supplier company information 17, the supplier product information 18c, the matching unit 130, the logistics information 19, and the logistics engine unit 150.

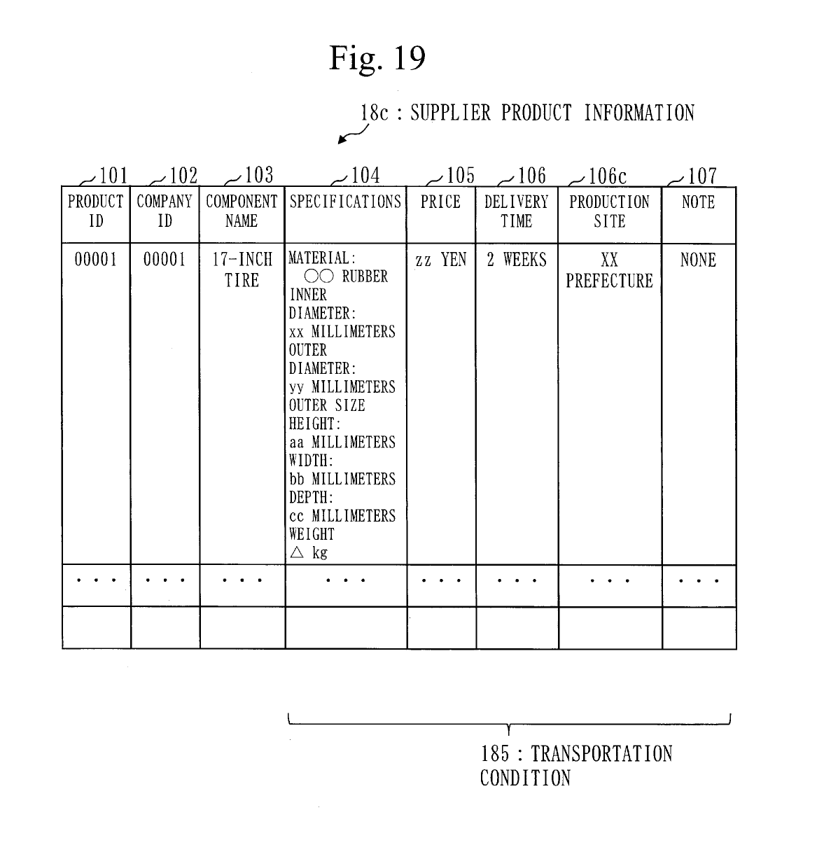

FIG. 19 is a configuration diagram of the supplier product information 18c in the present embodiment. In FIG. 19, constituents similar to those illustrated in FIG. 8 in the embodiment 1 are assigned the respective same reference characters, and the description thereof is omitted.

The supplier product information 18c includes a transportation condition 185 of a supply product which the supplier supplies. The supplier product information 18c includes, as the transportation condition 185 of a supply product, a size and weight of the supply product and a production site of the supply product.

In the supplier product information 18c, the dimensions in height, width, and depth of a product and the weight thereof are set forth in the content of the specifications 104 illustrated in FIG. 8. Moreover, a production site 106c of each product is set forth as additional information to the supplier product information 18 illustrated in FIG. 8.

The dimensions in height, width, and depth in the specifications 104 represent the outer size of a product in a packing state, and the weight therein represents a weight in a packing state. These pieces of information are an example of the transportation condition 185 of a supply product, which is used to determine a transport condition of the supply product. Moreover, the production site 106c represents a place of manufacturing of a product, and serves as a shipping source when the buyer purchases the product. The production site 106c is also an example of the transportation condition 185 of a supply product.

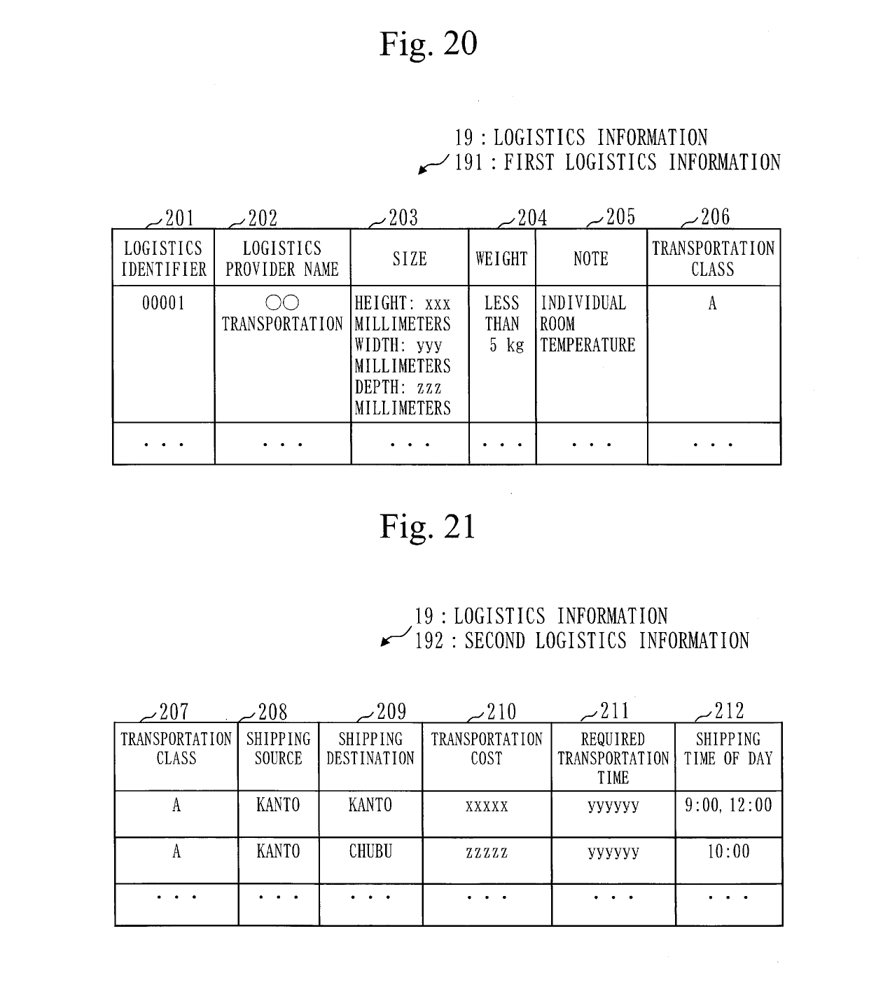

FIG. 20 is a configuration diagram of the first logistics information 191 in the present embodiment. FIG. 21 is a configuration diagram of the second logistics information 192 in the present embodiment. The logistics information 19 is information obtained by combining the first logistics information and the second logistics information.

In the logistics information 19, a logistics identifier 201 for identifying the logistics provider 491 and a transportation condition 195 under which the logistics provider 491 performs transportation are associated with each other. The transportation condition 195 includes a shipping source 208, a shipping destination 209, a transportation cost 210, and a required transportation time 211.

The first logistics information 191 is configured with pieces of information about a logistics identifier 201, logistics provider name 202, size 203, weight 204, note 205, and transportation class 206. The size 203, weight 204, and note 205 are an example of a transportation condition 195 under which the logistics provider name 202 performs transportation.

The second logistics information 192 is configured with pieces of information about a transportation class 207, shipping source 208, shipping destination 209, transportation cost 210, required transportation time 211, and shipping time of day 212. The logistics identifier 201 is a unique identifier allocated for determining the transportation condition 195. The logistics provider name 202 is the name of a business operator who handles the logistics concerned. The size 203 is information indicating the size, specifically, height, width, and depth, of a storage package in units of transportation during transportation. The weight 204 is a weight which is loadable in the storage package. The note 205 is information set concerning another transportation condition such as refrigerated transportation. The transportation class 206 is information indicating a relationship between a transportation section from the shipping source 208 to the shipping destination 209, the transportation cost 210, and the required transportation time 211 illustrated in FIG. 21. Thus, the transportation class 207 illustrated in FIG. 21 is the same information as the transportation class 206 illustrated in FIG. 20. The shipping source 208 is location information about the starting point of transportation. The shipping destination 209 is location information about the ending point of transportation. The transportation cost 210 is a cost of transportation performed under the transportation condition 195 represented by the size 203 to the shipping destination 209. The required transportation time 211 is an amount of time required for transportation also performed under the transportation condition represented by the size 203 to the shipping destination 209. The shipping time of day 212 is information about time of day at which the transportation concerned is performed for shipping.

The logistics engine unit 150 selects a logistics provider 491 which satisfies a transportation condition of the desired purchase product extracted by the transaction unit 110, based on the supplier product information 18c and the logistics information 19. Moreover, the logistics engine unit 150 calculates a transportation cost and a required transportation time required when the selected logistics provider 491 transports the desired purchase product extracted by the transaction unit 110 from a shipping source to a shipping destination. In the logistics information 19, the logistics identifier 201 for identifying the selected logistics provider 491 is associated with the shipping source 208, the shipping destination 209, the transportation cost 210, and the required transportation time 211.

### Description of Operation

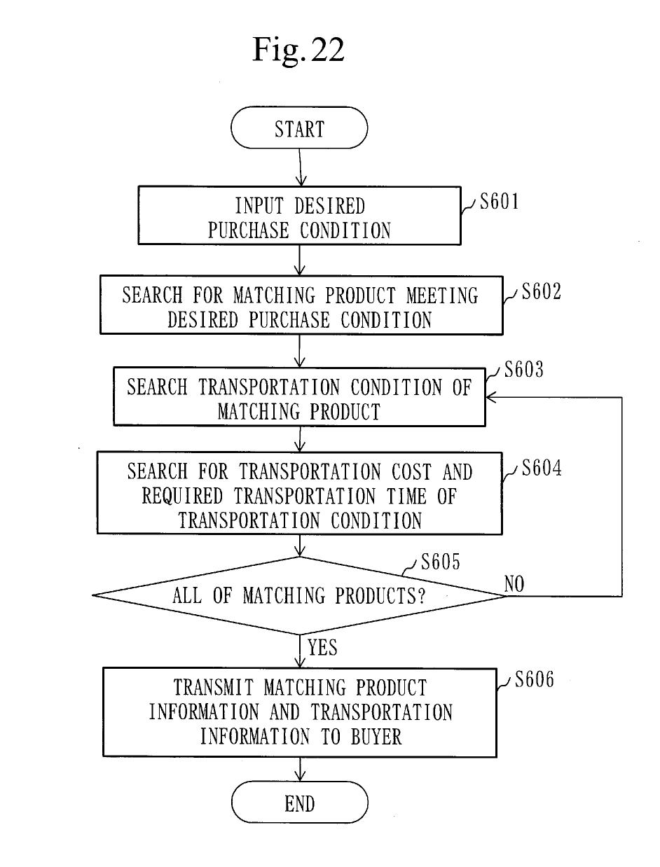

Supplier product presentation processing performed by the mediation apparatus 10c in the present embodiment is described with reference to FIG. 22.

First, advance preparation processing, which is performed in advance, is described.

In addition to the advance preparation processing described in the embodiment 1, setting of the supplier product information 18c and setting processing of the logistics information 19 are performed.

The supplier 30 connects the supplier terminal 31 to the transaction unit 110 and then inputs the supplier product information 18c to the extent possible, as in the embodiment 1.

Moreover, the logistics provider 491 connects the logistics provider terminal 492 to the transaction unit 110 and then inputs the logistics information 19 to the extent possible.

The supplier product presentation processing illustrated in FIG. 22 is processing for the mediation apparatus 10c to select a supplier 30 in consideration of the transportation cost and the required transportation time and to present the selected supplier 30 to the buyer 20.

In step S601, the transaction unit 110 receives, from the buyer terminal 21 via the Internet 40, a supply product extraction request for searching the supplier product information 18c for a supply product satisfying a condition written in the desired purchase information 14. Specifically, the buyer 20 connects the buyer terminal 21 to the transaction unit 110 and then transmits, to the transaction unit 110, a supply product extraction request for searching the supplier product information 18c for a supply product satisfying a condition written in information for the desired purchase information 14 input by the buyer 20.

In step S602, the transaction unit 110 searches the supplier product information 18c for a supplier product matching the supply product extraction request. Here, if there is no supplier product matching the supply product extraction request, the transaction unit 110 ends the processing.

If there is a product matching the supply product extraction request, the transaction unit 110 advances to step S603. Here, the product matching the supply product extraction request is assumed to be a matching product. The matching product is an example of a desired purchase product extracted by the transaction unit 110. Furthermore, processing in step S601 to step S602 is processing similar to the processing in step S201 to step S202 illustrated in FIG. 9 in the embodiment 1.

In step S603, the transaction unit 110 communicates, to the logistics engine unit 150, the specifications 104 written in the supplier product information 18c with respect to the matching product. Then, the logistics engine unit 150 extracts, from the first logistics information 191, a logistics identifier 201 in which the size 203 and the weight 204 applicable to the specifications 104 are set as the transportation condition 195.

In step S604, the logistics engine unit 150 determines a shipping source and a shipping destination based on the buyer company information 13 and the production site 106c of the supplier product information 18c. Moreover, the logistics engine unit 150 determines the transportation cost 210 and the required transportation time 211 based on the transportation class 206, the shipping source 208, and the shipping destination 209 of the logistics identifier 201 extracted in step S603.

In step S605, the logistics engine unit 150 determines whether the processing has ended with respect to all of the matching products. If the processing has ended with respect to all of the matching products, the logistics engine unit 150 advances to step S606. If there is a matching product which is not yet subjected to the processing, the logistics engine unit 150 returns to step S603.

In step S606, the logistics engine unit 150 transmits the matching product and the transportation cost and required transportation time of the matching product to the buyer terminal 21. Specifically, the logistics engine unit 150 transmits, to the buyer terminal 21, the transportation cost and required transportation time required to transport the matching product together with the supplier company information 17 and the supplier product information 18c corresponding to the matching product. In this case, the logistics engine unit 150 can transmit them as a total price and total delivery time of the matching products or can transmit them individually.

### Description of Advantageous Effects of Present Embodiment

In the mediation apparatus 10c according to the present embodiment, outer size information in the specifications 104 and information about a production site are written in the supplier product information. Moreover, in the mediation apparatus 10c, information about the size and weight required for transportation and the transportation cost and required transportation time required for a transportation section is set to the logistics information. Therefore, in the mediation apparatus 10c according to the present embodiment, concurrently with the supplier product search, the buyer is able to know the transportation cost and the required transportation time. Therefore, in the mediation apparatus 10c according to the present embodiment, the user is freed from the individual estimation of a product and transportation, and is able to quickly find a product most appropriate as viewed in totality.

The mediation apparatus 10c according to the present embodiment is effective for looking for a new procurement destination during corporate customer business, what is called B-to-B component procurement. Furthermore, the mediation apparatus 10c becomes especially effective for a case where procurement destinations frequently change as in private customer business, what is called B-to-C. The user determines whether to prioritize price or prioritize delivery time and is thus able to find a product procurement destination meeting such a condition in one processing operation. Moreover, since the user is enabled to list a plurality of transportation means as candidates with respect to a given supplier product, even when a product to be procured is already determined, a cost reduction or time shortening can be effectively attained.

Moreover, the mediation apparatus 10c according to the present embodiment can be applied to a case where, as described in the embodiment 2, the matching unit 130 automatically searches the supplier product information 18c for a supplier product matching a condition based on the previously registered desired purchase information 14. Specifically, designating a price including the transportation cost or a delivery time including the required transportation time as a condition enables automatically selecting a product meeting the condition in totality.

### Embodiment 5

In the present embodiment, differences from the embodiment 4 are mainly described.

In the present embodiment, constituents similar to the constituents described in the embodiments 1 to 4 are assigned the respective same reference numerals, and the description thereof is omitted.

In the embodiment 4, a method in which the buyer looks for a product to be procured from the supplier has been described. However, from the viewpoint of logistics provides, there is a demand to collectively perform shipping for transportation in near transportation sections whenever possible. Then, if collectively performing shipping is attained, shipping cost of products which are collectively dispatched is shared, so that shipping cost per product can be reduced to a low value.

### Description of Configuration

Configurations of a mediation system 500c and a mediation apparatus 10c according to the present embodiment are similar to those described in the embodiments 1 to 4.

Furthermore, in the present embodiment, the transaction information 15 is an example of transaction data representing information about a transaction product the transaction of which has been finalized between a buyer and a supplier.

In the present embodiment, the logistics engine unit 150 extracts, from the transaction information 15, a transaction product able to be packed together with an order product which the buyer has ordered, based on the transaction information 15 and the logistics information 19. Moreover, the logistics engine unit 150 calculates a transportation cost and a required transportation time required when the order product and the transaction product packed together are transported.

### Description of Operation

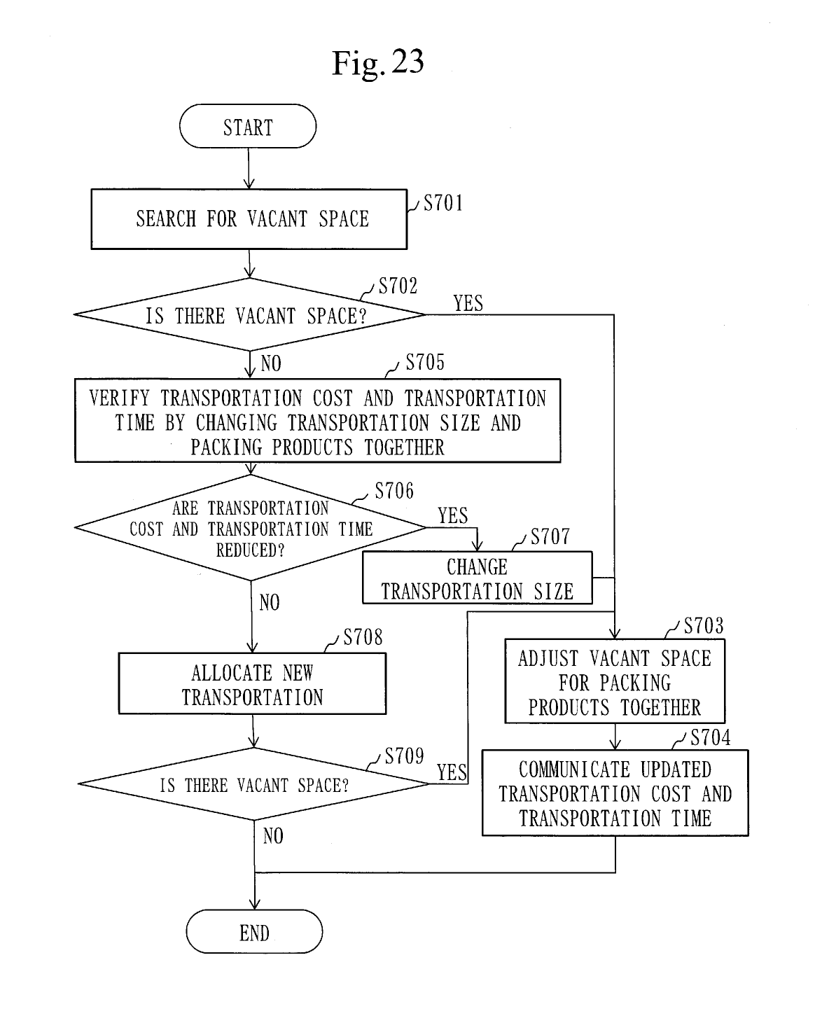

Transportation calculation processing performed by the mediation apparatus 10c according to the present embodiment is described with reference to FIG. 23.

The transportation calculation processing in the present embodiment is processing performed when the buyer newly intends to order an order product. The logistics engine unit 150 searches the transaction information 15 for a finalized order, and performs the following processing in sequence. The finalized order is assumed to be a transaction product.

In step S701, the logistics engine unit 150 makes a search to determine whether the logistics information 19 in which the transportation condition written in the shipping source 208, shipping destination 209, and note 205 is the same as that of the order product indicates that there is a vacant space in which the order product can be packed together with the transaction product. Specifically, the logistics engine unit 150 extracts a logistics identifier 201 in which the transportation condition written in the shipping source 208, shipping destination 209, and note 205 is the same and there is a vacant space in which the order product can be packed together. The logistics engine unit 150 sets a size obtained by multiplying the outer size written in the specifications 104 of the supplier product information 18c corresponding to the order product by the number of orders as the size of the order product. The logistics engine unit 150 compares the size of the order product with the size 203 of the logistics information 19, and makes an evaluation of whether a space for the size of the order product can be ensured and the weight also falls within the range.

If a space for the size of the order product can be ensured and the weight also falls within the range, the logistics engine unit 150 determines that there is a vacant space.

If, in step S702, there is a vacant space, the logistics engine unit 150 advances to step S703. If, in step S702, there is no vacant space, the logistics engine unit 150 advances to step S705.

In step S703, the logistics engine unit 150 makes an adjustment in such a way as to perform transportation with the order product packed together in the vacant space. The logistics engine unit 150 calculates the number of times of transportation and a cost which are required in a case where transportation is performed with the order product packed together in the vacant space. In a case where transportation is performed with the order product packed together, the number of times of transportation and the cost are reduced.

In step S704, since the transportation cost of the transaction product, which is a finalized order, is also shared with that of a new order, the logistics engine unit 150 or the transaction unit 110 notifies the buyer 20 who has finalized the order that the transportation cost has decreased.

In step S705, the logistics engine unit 150 makes a search to determine whether the logistics information 19 in which the transportation condition written in the shipping source 208, shipping destination 209, and note 205 is the same as that of the order product indicates that there is a vacant space in which the order product can be packed together with the transaction product. The logistics engine unit 150 verifies whether, in a case where the size 203 or the weight 204 is changed to a slightly larger one, transportation can be performed with the order product and the transaction product packed together. Moreover, if it is verified that transportation can be performed with the order product and the transaction product packed together, the logistics engine unit 150 verifies whether the transportation cost and the required transportation time of the transaction product of the finalized order required when the transportation cost is shared by the transaction product and the order product do not exceed the values required up to this point.

In step S706, the logistics engine unit 150 determines whether the order product and the transaction product can be packed together and the transportation cost and the required transportation time of the transaction product do not exceed the values required when the order product and the transaction product are not packed together. If, those do not exceed the values required up to this point, the logistics engine unit 150 advances to step S707. If those exceed the values required up to this point, the logistics engine unit 150 advances to step S708.

In step S707, the logistics engine unit 150 changes the size 203 or the weight 204 in the logistics information 19 to a slightly larger one, and then advances to step S703. Then, the logistics engine unit 150 makes an adjustment in such a way as to perform transportation with the current order product and the transaction product packed together, and the transaction unit 110 notifies the buyer 20 of the transaction product that the transportation cost has decreased or the delivery time has shortened.

In step S708, since the order product cannot be packed together with the transaction product, the logistics engine unit 150 allocates new transportation to the current order product.

In step S709, the logistics engine unit 150 determines whether the transaction product in the same transportation condition can be packed in a vacant space in new transportation. If the transaction product can be packed to the extent that the transportation cost and the delivery time do not increase, the logistics engine unit 150 advances to step S703, and then performs adjustment of packing them together and a notification to the buyer of the transaction product.

Furthermore, in the above-described procedure, when packing products together is considered, attention should be paid to the following respects.

(a) When a vacant space is confirmed, by reference to the supplier product information 18c, it should be confirmed that each product is not a product marked “right side up with care”. If the product is a product marked “right side up with care”, the upper and lower sides of the product should be fixed, and the posture of the product should be considered.
(b) When a vacant space is confirmed, by reference to the supplier product information 18c, the allowable weight of upper load should be confirmed. In a case where upper load is not permitted with respect to a product, the product should be placed in such a manner that another product is not loaded on top of the product.
(c) With regard to sharing of the transportation cost at the time of packing products together, each allocation should be determined based on the occupation area or weight of each product.
(d) With regard to the delivery time at the time of packing products together, the arrival of a product of the originally finalized order at a buyer base should not be delayed. Therefore, in consideration of the delivery time 106 of a product and the shipping time of day 212 from a logistics base, such logistics means that the product is dispatched at or after the time of the product arriving at a shipping source logistics base and arrives at or before the originally finalized time of the product arriving at a shipping destination logistics base should be selected.

### Description of Advantageous Effects of Present Embodiment

In the mediation apparatus 10c according to the present embodiment, making positive use of packing products together enables, with respect to each order, shortening the transportation time with the same price, decreasing the price with the same transportation time, or attaining both of them. However, to carry out packing products together, it is necessary to grasp order situations of other people, and it is generally difficult to achieve this from the viewpoint of security and privacy. However, according to the present embodiment, since the mediation system 500c is able to make a determination of whether collectively packing products together is available and to make an actual arrangement for packing products together, the transportation time and price can be reduced with security and privacy maintained.

Moreover, up to now, logistics providers have shaped the posture of a cargo to realize optimal transportation, according to logistics requests occurring in real time. However, since the mediation system 500c according to the present embodiment can assist logistics providers, only performing actual transportation based on shipping information transmitted from the mediation apparatus 10c, which is a transaction server, enables realizing optimal transportation.

In the mediation apparatus 10c according to the present embodiment, during transportation of a product purchased by the buyer, an adjustment for transporting the product packed together with a transaction product can be made in consideration of the size of a transportation unit of the product, the allowable weight, the transportation section, other transportation conditions, and a transportation condition of the finalized order.

While the embodiments 1 to 5 of the present invention have been described above, only any one of those each described as a “unit” in the description of these embodiments can be employed, or an optional combination of some units can be employed. In other words, a functional block of the mediation apparatus is optional as long as it is capable of attaining any function described in the above embodiments. The mediation apparatus can be configured with any combination of these functional blocks or with an optional block configuration. Moreover, the mediation apparatus can be configured with not only a single apparatus but also a plurality of apparatuses.

Moreover, while the embodiments 1 to 5 have been described, a plurality of parts of these embodiments can be combined for implementation. Alternatively, one part of these embodiments can be implemented. Besides, contents of these embodiments can be totally or partially implemented in any combination manner.

Furthermore, the above-described embodiments are essentially favorable examples, and, therefore, are not intended to limit the present invention and the range of its applicable things and use application and can be modified or altered in various manners as needed.

### REFERENCE SIGNS LIST

10, 10a, 10b, 10c: mediation apparatus; 12: buyer evaluation information; 13: buyer company information; 14: desired purchase information; 15: transaction information; 16: supplier evaluation information; 17: supplier company information; 18, 18c: supplier product information; 20: buyer; 21: buyer terminal; 30: supplier; 31: supplier terminal; 40: Internet; 41, 51, 61: transaction ID; 71, 81: company ID; 42: date and time; 43: buyer; 44: supplier; 45, 73, 83: product; 46: quantity; 47, 56, 66, 78, 88, 98, 107: note; 52, 62: evaluation date and time; 53: requested quality; 54: requested price; 55: requested delivery time; 63: supplied quality; 64: supplied price; 65: supplied delivery time; 72, 82: company name; 74: wholesale destination; 75, 85: base; 76: component delivery method; 77, 87: scale; 84: purchase destination; 86: production equipment; 91: desired purchase product ID; 101: product ID; 92, 102: company ID; 93, 103: component name; 94, 104: specifications; 95: desired price; 96: desired quantity; 97: desired delivery time; 105: price; 106: delivery time; 110: transaction unit; 120: storage unit; 130: matching unit; 140: trend analysis unit; 500, 500c: mediation system; 510: mediation method; 520: mediation program; 511: buyer evaluation data; 610: supplier evaluation data; S100, S200: transaction processing; S400: matching processing; S500: trend notification processing; 909: processing circuit; 910: processor; 920: storage device; 930: input interface; 940: output interface; 950: communication interface; 185, 195: transportation condition; 19: logistics information; 191: first logistics information; 192: second logistics information; 491: logistics provider; 492: logistics provider terminal; 201: logistics identifier; 202: logistics provider name; 203: size; 204: weight; 205: note; 206, 207: transportation class; 208: shipping source; 209: shipping destination; 210: transportation cost; 211: required transportation time; 212: shipping time of day; 106c: production site; 150: logistics engine unit.

1.-17. (canceled)

18. A mediation apparatus comprising:
processing circuitry
to store desired purchase information including information about a desired purchase product which a buyer desires to purchase, supplier company information indicating information about a company of a supplier, and supplier product information including information about a supply product which a supplier supplies, and
to select a supplier as a selected supplier from the supplier company information based on the desired purchase information, to determine a degree to which specifications of a supply product which the selected supplier supplies match specifications of the desired purchase product, to analyze a difference between the specifications of the supply product which the selected supplier supplies and the specifications of the desired purchase product in a case where the degree is smaller than a threshold value, and to determine, based on a result of analysis, whether to extract information about the supply product of the selected supplier from the supplier product information.

19. A mediation apparatus comprising:
processing circuitry
to store desired purchase information including information about a desired purchase product which a buyer desires to purchase, transaction information indicating information about a product with respect to which a transaction was performed between a buyer and a supplier, and supplier product information including information about a supply product which a supplier supplies, and
to extract a trend product which tends to be traded, based on the desired purchase information and the transaction information, to, in a case where there is a difference between specifications of the trend product and specifications of the supply product based on the trend product and the supplier product information, analyze the difference, and to communicate, to the supplier, a trend notification concerning the trend product based on a result of analysis.

20. The mediation apparatus according to claim 18, wherein the processing circuitry
further stores buyer evaluation information including buyer evaluation data obtained by evaluating a buyer, and
further acquires a desired purchase extraction request for extracting information about a desired purchase product from the desired purchase information, based on a supply condition indicating a condition of a supply product which a supplier supplies and a buyer evaluation condition indicating a condition of the buyer evaluation data which the supplier desires to a buyer who is a supply destination to which the supply product is supplied, and extracts information about a desired purchase product from the desired purchase information based on the supply condition, the buyer evaluation condition, the desired purchase information, and the buyer evaluation information.

21. The mediation apparatus according to claim 20, wherein the processing circuitry
further stores supplier evaluation information including supplier evaluation data obtained by evaluating a supplier, and
acquires a supply product extraction request for extracting information about a supply product from the supplier product information, based on a purchase condition indicating a condition of the desired purchase product and a supplier evaluation condition indicating a condition of the supplier evaluation data which the buyer desires to a supplier who supplies the desired purchase product, and extracts information about a supply product from the supplier product information based on the purchase condition, the supplier evaluation condition, the supplier product information, and the supplier evaluation information.

22. The mediation apparatus according to claim 21,
wherein the buyer evaluation information includes the buyer evaluation data with respect to each of a requested quality, requested price, and requested delivery time which a buyer requested about a purchase product which the buyer previously purchased, and
wherein the supplier evaluation information includes the supplier evaluation data with respect to each of a supplied quality, supplied price, and supplied delivery time of a supplied product which a supplier previously supplied.

23. The mediation apparatus according to claim 22, wherein, when acquiring the desired purchase extraction request, the processing circuitry extracts, from the desired purchase information, information about a desired purchase product which satisfies the supply condition and which a buyer whose buyer evaluation data satisfies the buyer evaluation condition desires to purchase.

24. The mediation apparatus according to claim 23, wherein, when acquiring the supply product extraction request, the processing circuitry extracts, from the supplier product information, information about a supply product which satisfies the purchase condition and which a supplier whose supplier evaluation data satisfies the supplier evaluation condition supplies.

25. The mediation apparatus according to claim 24, wherein the processing circuitry
stores buyer company information indicating information about a company of a buyer and supplier company information indicating information about a company of a supplier, and
extracts information about a desired purchase product from the desired purchase information based on the buyer company information, and extracts information about a supply product from the supplier product information based on the supplier company information.

26. The mediation apparatus according to claim 20,
wherein the supplier product information includes a transportation condition of a supply product which a supplier supplies, and
wherein the processing circuitry
further stores logistics information in which a logistics identifier for identifying a logistics provider and a transportation condition under which the logistics provider performs transportation are associated with each other, and
further selects a logistics provider which satisfies a transportation condition of a desired purchase product extracted, based on the supplier product information and the logistics information.

27. The mediation apparatus according to claim 26, wherein the processing circuitry calculates a transportation cost and a required transportation time required when the selected logistics provider transports a desired purchase product extracted, from a shipping source to a shipping destination.

28. The mediation apparatus according to claim 27, wherein the processing circuitry stores, in the logistics information, a logistics identifier for identifying the selected logistics provider, the shipping source, the shipping destination, the transportation cost, and the required transportation time in association with each other.

29. The mediation apparatus according to claim 26, wherein the processing circuitry
stores transaction data indicating information about a transaction product for which a transaction has been finalized between a buyer and a supplier, and
extracts, from the transaction data, a transaction product which is able to be packed together with an order product which a buyer has ordered, based on the transaction data and the logistics information.

30. The mediation apparatus according to claim 29, wherein the processing circuitry calculates a transportation cost and a required transportation time required when the order product and the transaction product are transported in a state of being packed together.

31. A mediation method that mediates a transaction between a buyer and a supplier,
wherein the mediation method comprises storing desired purchase information including information about a desired purchase product which a buyer desires to purchase, supplier company information indicating information about a company of a supplier, and supplier product information including information about a supply product which a supplier supplies,
the mediation method comprising: selecting a supplier as a selected supplier from the supplier company information based on the desired purchase information; determining a degree to which specifications of a supply product which the selected supplier supplies match specifications of the desired purchase product; analyzing a difference between the specifications of the supply product which the selected supplier supplies and the specifications of the desired purchase product in a case where the degree is smaller than a threshold value; and determining, based on a result of analysis, whether to extract information about the supply product of the selected supplier from the supplier product information.

32. A mediation method that mediates a transaction between a buyer and a supplier,
wherein the mediation method comprises storing desired purchase information including information about a desired purchase product which a buyer desires to purchase, transaction information indicating information about a product with respect to which a transaction was performed between a buyer and a supplier, and supplier product information including information about a supply product which a supplier supplies,
the mediation method comprising: extracting a trend product which tends to be traded, based on the desired purchase information and the transaction information; in a case where there is a difference between specifications of the trend product and specifications of the supply product based on the trend product and the supplier product information, analyzing the difference; and communicating, to the supplier, a trend notification concerning the trend product based on a result of analysis.

33. A non-transitory computer readable medium storing a mediation program of a mediation apparatus that mediates a transaction between a buyer and a supplier,
wherein the mediation apparatus comprises a storage unit to store desired purchase information including information about a desired purchase product which a buyer desires to purchase, supplier company information indicating information about a company of a supplier, and supplier product information including information about a supply product which a supplier supplies,
the mediation program causing the mediation apparatus serving as a computer to perform matching processing of: selecting a supplier as a selected supplier from the supplier company information based on the desired purchase information; determining a degree to which specifications of a supply product which the selected supplier supplies match specifications of the desired purchase product; analyzing a difference between the specifications of the supply product which the selected supplier supplies and the specifications of the desired purchase product in a case where the degree is smaller than a threshold value; and determining, based on a result of analysis, whether to extract information about the supply product of the selected supplier from the supplier product information.

34. A non-transitory computer readable medium storing a mediation program of a mediation apparatus that mediates a transaction between a buyer and a supplier,
wherein the mediation apparatus comprises a storage unit to store desired purchase information including information about a desired purchase product which a buyer desires to purchase, transaction information indicating information about a product with respect to which a transaction was performed between a buyer and a supplier, and supplier product information including information about a supply product which a supplier supplies,
the mediation program causing the mediation apparatus serving as a computer to perform trend notification processing of: extracting a trend product which tends to be traded, based on the desired purchase information and the transaction information; in a case where there is a difference between specifications of the trend product and specifications of the supply product based on the trend product and the supplier product information, analyzing the difference; and communicating, to the supplier, a trend notification concerning the trend product based on a result of analysis.

35. The mediation apparatus according to claim 19, wherein the processing circuitry
further stores buyer evaluation information including buyer evaluation data obtained by evaluating a buyer, and
further acquires a desired purchase extraction request for extracting information about a desired purchase product from the desired purchase information, based on a supply condition indicating a condition of a supply product which a supplier supplies and a buyer evaluation condition indicating a condition of the buyer evaluation data which the supplier desires to a buyer who is a supply destination to which the supply product is supplied, and extracts information about a desired purchase product from the desired purchase information based on the supply condition, the buyer evaluation condition, the desired purchase information, and the buyer evaluation information.
